(19) United States
(12) Patent Application Publication
(10) Pub. No.: US 2020/0336541 A1
(43) Pub. Date: Oct. 22, 2020

(54) Vehicle Sensor Data Acquisition and Distribution

(71) Applicant: QUALCOMM Incorporated, San Diego, CA (US)

(72) Inventors: Mohammadhossein Naderi Alizadeh, San Diego, CA (US); Shahin Mehdizad Taleie, San Diego, CA (US)

(21) Appl. No.: 16/385,400

(22) Filed: Apr. 16, 2019

(51) Int. Cl. H04L 29/08; G06F 11/30; G05D 1/00; H04L 29/06

(52) U.S. Cl. CPC H04L 67/12; G06F 11/3013; H04L 67/42; G05D 1/0088; G06F 11/3089

(57) ABSTRACT

Various aspects enable sensor data to be obtained from vehicles. Various aspects may enable data gathered by sensors of vehicles to be obtained by a data agency server and made available to third party client devices. In various aspects, a data agency server may direct a vehicle to drive from the vehicle's current location to a different specific location to gather a type of data. In some aspects, the type of data may be peripheral data that is not associated with driving operations of a vehicle. In some aspects, a data agency server may indicate one or more attributes of collection for the vehicle to utilize in gathering data. In some aspects, an attribute of collection may set a condition of the vehicle and/or the sensor utilized in gathering data. In some embodiments, vehicle owners/operators may be compensated for their vehicles being utilized to obtain data.

### BACKGROUND

Automobiles and trucks are becoming more intelligent as the surface transportation industry moves towards deploying autonomous and semi-autonomous vehicles. Autonomous and semi-autonomous vehicles can detect information about their location and surroundings (for example, using radar, lidar, global positioning system (GPS) receivers, odometers, accelerometers, cameras, and other sensors), and include control systems that interpret sensory information to identify hazards and determine navigation paths to follow. Autonomous and semi-autonomous vehicles include control systems to operate with limited or no control from an occupant or other operator of the automobile.

The surface transportation industry has increasingly looked to leverage the growing capabilities of cellular and wireless communication technologies to increase communication capabilities for both autonomous and semi-autonomous vehicles. The cellular vehicle-to-everything (C-V2X) protocol defined by the 3^{rd} Generation Partnership Project (3GPP) serves as a foundation for vehicles to communicate directly with the communication devices around them. C-V2X defines two transmission modes that, together, provide a 360 non-line-of-sight awareness and a higher level of predictability for enhanced road safety and autonomous driving. A first transmission mode includes direct C-V2X, which includes vehicle-to-vehicle (V2V), vehicle-to-infrastructure (V2I), and vehicle-to-pedestrian (V2P), and that provides enhanced communication range and reliability in the dedicated 5.9 gigahertz (GHz) spectrum that is independent of a cellular network. A second transmission mode includes vehicle-to-network communications (V2N) in mobile broadband systems and technologies, such as third generation wireless mobile communication technologies (3G) (e.g., global system for mobile communications (GSM) evolution (EDGE) systems, code division multiple access (CDMA) 2000 systems, etc.), fourth generation wireless mobile communication technologies (4G) (e.g., long term evolution (LTE) systems, LTE-Advanced systems, mobile Worldwide Interoperability for Microwave Access (mobile WiMAX) systems, etc.), fifth generation wireless mobile communication technologies (5G) (e.g., 5G New Radio (5G NR) systems, etc.), etc.

### SUMMARY

Systems, methods, and devices of the various aspects enable sensor data to be obtained from vehicles. Various aspects may enable data gathered by sensors of vehicles, such as autonomous and semi-autonomous vehicles, to be obtained by a data agency server and made available to third party client devices, such as data client servers. In some aspects, a data agency server may direct a vehicle to drive from the vehicle's current location to a different specific location to gather a type of data. In some aspects, the type of data may be peripheral data that is not associated with driving operations of a vehicle. In some aspects, a data agency server may indicate one or more attributes of collection for the vehicle to utilize in gathering data. In some aspects, one or more attributes of collection may set one or more conditions of the vehicle and/or any sensors utilized in gathering data, such as a type of wireless connection to establish to send gathered data, a sensor to use in gathering the type of data, vehicle speed, vehicle direction, headlight mode, sensor angle, sensor height, sensor mode, engine state, etc. In some aspects, vehicle owners/operators may be compensated for their vehicles being utilized to obtain data.

Various aspects may provide for obtaining sensor data from a vehicle. Various aspects may include receiving a data gathering request from a data agency server, wherein the data gathering request indicates a type of data and a specific location at which to gather the type of data, gathering the type of data at the specific location, and sending gathered data to the data agency server. Various aspects may include driving the vehicle from a current location to the specific location in response to receiving the data gathering request. In various aspects, the data gathering request may further indicate an attribute of collection. In various aspects, the type of data may be data not associated with driving operations of the vehicle.

Various aspects may provide for obtaining sensor data from a vehicle. Various aspects may include receiving a request for data from a client server, the request for data indicating a specific location at which data is to be gathered and a type of requested data, generating a data gathering request in response to receiving the request for data, the data gathering request indicating the type of requested data and the specific location, sending the data gathering request to at least one vehicle, and receiving data from the at least one vehicle, wherein the received data corresponds to data collected at the specific location and of the type of requested data. Some aspects may further include sending the received data to the client server. In various aspects, sending the data gathering request to the at least one vehicle may include sending the data gathering request to at least one vehicle at a current location different from the specific location. In some aspects, the type of data may be peripheral data not associated with driving operations of the vehicle.

Some aspects may further include selecting from a plurality of vehicles the at least one vehicle at a location different from the specific location. Some aspects may further include determining an attribute of collection, wherein the request for data further indicates the attribute of collection. In some aspects, the attribute of collection may indicate a speed of travel while gathering the type of data. In some aspects, the attribute of collection may indicate a type of wireless connection to establish to send gathered data. In various aspects, the attribute of collection may indicate a sensor to use in gathering the type of data. In some aspects, the attribute of collection may indicate an address to which to send gathered data. In some aspects, the attribute of collection may indicate a time or duration for gathering the type of data. In some aspects, the attribute of collection may indicate a condition of the vehicle while gathering the type of data or a condition of a sensor to use in gathering the type of data.

Various aspects include a processor configured with processor-executable instructions to perform operations of the methods summarized above. Various aspects also include a non-transitory processor-readable medium on which is stored processor-executable instructions configured to cause a processor to perform operations of the methods summarized above. Various aspects also include a device including means for performing functions of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein

FIGS. 1A and 1B are schematic diagrams illustrating a vehicle suitable for implementing various embodiments.

FIG. 2 is a schematic block diagram illustrating components of an example vehicle management system according to various embodiments.

FIG. 3 is a schematic block diagram illustrating components of an example system on chip for use in a vehicle in accordance with various embodiments.

FIG. 4A is a schematic system diagram illustrating components of a vehicle data system suitable for implementing various embodiments.

FIG. 4B is a process flow diagram of an example method for registering vehicles for data acquisition according to various embodiments.

FIG. 5 is a process flow diagram of an example method for obtaining sensor data from a vehicle according to various embodiments.

FIG. 6 is a process flow diagram of an example method for selecting at least one vehicle according to various embodiments.

FIG. 7 is a process flow diagram of an example method for obtaining sensor data from a vehicle according to various embodiments.

FIG. 8 is a process flow diagram of an example method for processing gathered data according to various embodiments.

FIG. 9 is a process flow diagram of an example method for obtaining sensor data from a vehicle according to various embodiments.

FIG. 10 is a process flow diagram of an example method for obtaining sensor data from a vehicle according to various embodiments.

FIG. 11 is a process flow diagram of an example method for obtaining sensor data from a vehicle according to various embodiments.

FIG. 12 is a component diagram of an example server suitable for use with various embodiments.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Various embodiments include systems and methods that enable leveraging sensor and communication capabilities of autonomous and semi-autonomous vehicles to gather data on request and communicate such data to a server where the data may be made available to third party clients for a variety of purposes. Some embodiments facilitate providing incentivizes to vehicle owners/operators to make vehicles available for use in data gathering by autonomous and semi-autonomous vehicles.

As used herein, the term “computing device” refers to any one or all of vehicle control units, display sub-systems, driver assistance systems, vehicle controllers, vehicle system controllers, vehicle communication system, infotainment systems, vehicle display systems or subsystems, vehicle data controllers or routers, cellular telephones, smart phones, personal or mobile multi-media players, personal data assistants (PDAs), laptop computers, personal computers, tablet computers, smart books, palm-top computers, wireless electronic mail receivers, multimedia Internet enabled cellular telephones, vehicle controllers, and similar electronic devices which include a programmable processor and memory and circuitry configured to perform operations as described herein.

Various embodiments are described herein using the term “server” to refer to any computing device capable of functioning as a server, such as a master exchange server, web server, mail server, document server, content server, or any other type of server. A server may be a dedicated computing device or a computing device including a server module (e.g., running an application that may cause the computing device to operate as a server). A server module (e.g., server application) may be a full function server module, or a light or secondary server module (e.g., light or secondary server application) that is configured to provide synchronization services among the dynamic databases on receiver devices. A light server or secondary server may be a slimmed-down version of server-type functionality that can be implemented on a receiver device thereby enabling it to function as an Internet server (e.g., an enterprise e-mail server) only to the extent necessary to provide the functionality described herein.

The term “system-on-chip” (SOC) is used herein to refer to a set of interconnected electronic circuits typically, but not exclusively, including one or more processors, a memory, and a communication interface. The SOC may include a variety of different types of processors and processor cores, such as a general purpose processor, a central processing unit (CPU), a digital signal processor (DSP), a graphics processing unit (GPU), an accelerated processing unit (APU), a subsystem processor, an auxiliary processor, a single-core processor, and a multicore processor. The SOC may further embody other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SOCs may be integrated circuits (ICs) configured such that the components of the ICs reside on the same substrate, such as a single piece of semiconductor material (e.g., silicon, etc.).

Autonomous and semi-autonomous vehicles may include one or more sensors configured to gather data, such as radars, lidars, GPS receivers, odometers, accelerometers, cameras, microphones, gas sensors, thermal sensors, infrared sensors, ultrasonic sensors, and other sensors. Typically, sensors on an autonomous or semi-autonomous vehicle are utilized to gather data associated with driving operations of the vehicle. For example, data from forward looking cameras may be used to identify contours of the roadway as well as other vehicles in an intended path of travel. Data from sensors uses to support autonomous and semi-autonomous vehicle navigation may be useful for other purposes, such as determining traffic volume, identifying road hazards, detecting and imaging potholes in the roadway, imaging scenes adjacent to the roadway, etc.

Additionally, some sensors on autonomous and semi-autonomous vehicles may have the ability to gather data that is not directly associated with driving operations but of potential usefulness for other purpose. For example, a thermal sensor that measures the ambient temperature can provide data for tracking local temperatures, especially if the vehicle location information (e.g., from a GPS receiver) is combined with the temperature data. As another example, a rain sensor as part of a windshield wiper system can provide data on local precipitation when combined with vehicle location information.

Data gathered by an autonomous or semi-autonomous vehicle, whether the gathered data is associated with driving operations of the vehicle or is peripheral to driving operations, could be leveraged to provide information about the environment at the location of the vehicle if such data could be gathered and integrated with similar or different data from other vehicles. Thus, as autonomous or semi-autonomous vehicles travel, the vehicle data gathered in various locations by the one or more sensors of the vehicle may provide useful information about environmental conditions along the route.

Many entities attempt to utilize information about locations to assist in performance of their functions or operations. For example, road maintenance authorities (e.g., city transportation offices, state highway authorities, etc.) could benefit from information about road defects, such as locations and images of defects in pavement, locations and images of defects in pavement markings, locations and images of defective signs, identification of defective traffic lights, locations and images of damaged curbs or guardrails, etc. Gathering such information from vehicles would enable the authorities to organize repairs for such road defects without sending survey crews to locate and characterize such defects. As another example, emergency and first responders (e.g., fire and rescue services, the Federal Emergency Management Agency (FEMA), the National Flood Insurance Program, etc.) could benefit from information regarding emergency events to enable responses to such catastrophic events, such as detecting wildfires, floods, etc. As another example, utility companies (e.g., power companies, gas companies, etc.) will benefit from information about defects in their utility systems, such as faulty power lines, gas leaks, etc. As a further example, police forces (e.g., the Federal Bureau of Investigation (FBI), city police forces, etc.) could benefit from information related to potential crimes and criminals, such as to detect stolen vehicles, detect vehicles associated with an Amber Alert, detect criminals by facial recognition, detect explosives hidden in vehicles, etc. As a still further example, automobile insurance companies could benefit from information related to claims events, such as information about vehicle accidents, etc.

Typically, entities gather such information about locations by either sending employees (e.g., technicians, officers, agents, etc.) in vehicles to visually observe, or otherwise check, the locations and report back conditions at the locations. Sending employees to a scene to gather information is time consuming and can lead to response delays, requires employees that must be paid for even whether there is no condition requiring inspection, and involves upkeep, maintenance, and fuel costs for the vehicles. Typical alternatives to gathering such information about locations without the use of employees have included using surveillance cameras at the locations and/or satellite data. However, surveillance cameras and satellite data also have drawbacks. For example, surveillance cameras are fixed in place and a large complex and expensive network of cameras is required to provide coverage of a large location, such as a city or county. Satellite data is not available at all times for all locations, may not have the granularity needed by various entities, and can be unavailable under certain conditions, such as at night or in bad weather.

Systems, methods, and devices of various embodiments enable sensor data to be obtained from autonomous and semi-autonomous vehicles and communicated to a central service that enables the data to be accessed by third-parties. Various embodiments include systems and methods that permit entities (e.g., data clients) to request certain types of data at certain locations, and facilitate gathering of the requested data by various sensors of autonomous and semi-autonomous vehicles for communication to the central service where the information can be made available to the requesting entities. Various embodiments thereby enable entities to obtain sensor data from vehicles to assist the entities in performance of their functions or operations. Various embodiments include methods that enable data gathered by sensors of vehicles, such as autonomous and semi-autonomous vehicles, to be obtained by a data agency server and made available to third party client devices, such as data client servers.

Various embodiments may include a data agency server configured to communicate with autonomous and semiautonomous vehicles over a network, such as over a wireless network (e.g., a 5G network, etc.). The data agency server may exchange wireless communications, such as C-V2X communications (e.g., C2N communications, etc.), etc., with vehicles to obtain sensor data from the vehicles. The data agency server may store sensor data from the vehicles in a database of vehicle sensor data. The data agency server may be configured to communicate with computing devices of third-party entities (e.g., road maintenance authorities, emergency management authorities, utility companies, police forces, insurance companies, etc.), such as data client servers operated by the third-party entities, over a network, such as the Internet. The data agency server may exchange communications with a computing device of a third-party entity to receive requests for specified types of sensor data from specified locations, and to provide sensor data obtained from vehicles to the computing device of the third-party entity. As a specific example, a data client server may interface with a data agency server via an application programming interface (API) to request and obtain vehicle sensor data from the data agency server.

In various embodiments, a data agency server may receive a request for data, such as from a data client server. For example, the request for data may be received from a data client server via an API. A request for data may be a request by the data client server to obtain vehicle sensor data from the data agency server. For example, the request for data may be a message requesting vehicle sensor data from the data agency server.

In various embodiments, the request for data may indicate a specific location at which data is to be gathered and/or a type of requested data. A specific location at which data is to be gathered may be any type of indication of a location, such as a specific geographic point (e.g., a latitude and longitude, another type of coordinate, etc.), a specific geographic place (e.g., a parking lot name, a road intersection name, etc.), an address, a roadway name (e.g., a street name, a highway number, etc.), a geographic area (e.g., a county, a city, a country, a neighborhood, a park, etc.), a geofence (e.g., a radius extending from a coordinate, etc.), etc. The type of requested data may be an indication of the format of the data being requested, such as still image, video, audio, temperature measurement, radar measurement, lidar measurement, acceleration measurement, speed measurement, gas measurement, infrared measurement, ultrasonic measurement, meter reading, etc. In some embodiments, the type of data may be peripheral data that is not associated with driving operations of a vehicle. For example, the type of data may be data collected by a sensor not supporting autonomous or semiautonomous driving (e.g., a temperature sensor, a gas sensor, a microphone, etc.).

In various embodiments, the request for data may additionally indicate an attribute of collection. An attribute of collection may be an indication of one or more requirements associated with collection of the data being requested. In some embodiments, an attribute of collection may specify or set one or more conditions of the vehicle and/or any sensors utilized in gathering data, such as vehicle speed, vehicle direction, headlight mode, sensor angle, sensor height, sensor mode, engine state, etc. A request for data may include one or more attributes of collection. As an example, attributes of collection may include indications of one or more specific sensors to be used in gathering the data (e.g., the data should be gathered using a radar, the data should be gathered using a specific type of camera, the data should be gathered using a gas sensor, etc.). As an example, attributes of collection may include an indication of speed of travel at which the data may be gathered (e.g., a specific miles per hour (mph), a minimum mph, a maximum mph, etc.). As an example, attributes of collection may include an indication of a type of wireless connection to use in transmitting the data (e.g., 5G broadband connection, etc.). As an example, attributes of collection may include an indication of a time or duration over which the data should be gathered (e.g., a specific time period, a starting time, an ending time, etc.). As an example, attributes of collection may include indications of one or more data conditions (e.g., send data associated with a temperature that is above a threshold, send data associated with an acceleration measurement at or above a threshold, send data associated with one or more conditions, etc.). As an example, attributes of collection may include indications of the one or more conditions of the vehicle and/or any sensors utilized in gathering data. Non-limiting examples of such indications may include: an indication of a specific speed and direction for the vehicle to be traveling during data gathering data; an indication a specific acceleration for the vehicle to be experiencing while gathering data; an indication of whether to have the headlight mode be “on” or “off” while gathering data; an indication of a height and angle of a camera to use in recording video, an indication of whether to have the engine be “on” or “off” while gathering data; an indication to follow a specific object while gathering data; and an indication to follow a specific route while gathering data. Attributes of collection may enable third party client devices, such as data client servers, and the entities that control those devices to tailor requests for vehicle data.

In various embodiments, a data agency server may determine one or more attributes of collection in response to receiving a request for data. For example, a data agency server may determine one or more attributes of collection by parsing a request for data. Determining one or more attributes of collection may be optional as all requests for data may not include attributes of collection.

In various embodiments, a data agency server may determine whether any of the requested data is available in a database, such as a database of previously obtained vehicle sensor data. In some embodiments, a data agency server may make this determination in response to receiving a request for data. In some embodiments, a data agency server may determine whether requested data is available in the database in response to determining one or more attributes of collection.

In various embodiments, a database of vehicle sensor data may be indexed and searchable by the data agency server. For example, vehicle sensor data in the database may be indexed by location at which data was gathered, by type of data, by attributes of collection associated with the collection of the data itself (e.g., type of sensor used, speed of travel at gathering, type of wireless connection used to transmit the data, time the data was gathered, duration over which the data was gathered, etc.), by vehicle collecting the data, and/or other characteristics. In various embodiments, the vehicle sensor data in the database may include or be cross referenced to location information (e.g., a GPS coordinate, etc.) indicating the location at which the data was collected and time information (e.g., a timestamp, etc.) indicating the time at which the data was collected. In various embodiments, the vehicle sensor data in the database may be anonymized such that the identity of the vehicle that collected individual data reports cannot be determined.

In various embodiments, the data agency server may determine whether requested data is available in a database of vehicle sensor data by searching the database to find any data that meets all requirements of the request for data (e.g., gathered at the specific location, of the type of requested data, and, when included, having all attributes of collection in the received request for data). Searching the database may include high level search operations, such as to merely compare index information for data to a search criteria, etc., and/or granular search operations, such as analyzing the data to detect attributes within the data matching a search criteria (e.g., to detect a specific vehicle license plate in image data, to detect a specific face by facial recognition in image data, to detect the presence of explosive materials, to detect a road defect, to detect power line power line sag, to detect a fire, to detect a flood, to detect an auto accident, etc.). As a specific example, the data agency server may determine whether any sensor data of a type requested (e.g., image, audio, radar, temperature, etc.) gathered in a specific city is available in the database. As another specific example, the data agency server may determine whether any infrared and temperature sensor data in the database indicates the presence of a wildfire in a national park. As another specific example, the data agency server may determine whether any sensor data in the database indicates the presence of a flood in a state. As another specific example, the data agency server may determine whether any camera, temperature sensor, and/or audible noise data in the database indicates a power line is sagging in a city. As another specific example, the data agency server may determine whether any camera image data in the database indicates a road defect is present on a city street, such as defects in pavement, defects in pavement markings, defective signs, defective lights, defective curbs, an obstacle in the street (e.g., a fallen tree, exploded tire, etc.), etc. As another specific example, the data agency server may determine whether any sensor data in the database indicates explosive materials are hidden in any vehicles in a city. As another specific example, the data agency server may determine whether any camera data of a specific intersection at a specific time is available. As another specific example, the data agency server may determine whether any wireless utility meter readings are available in the database for a given city. Finding data that matches all the requirements of the request for data may indicate that the requested data is available in the database. Finding no data that matches all the requirements of the request for data may indicate that the requested data is not available in the database.

In some cases, the data request may include an attribute for collection that will indicate to the data agency server that the requested data is necessarily not in the database. For example, a data request may include an attribute of collection that sets a time for gathering the data that is equal to a current time (e.g., a request for real-time data), or that is after the current time (i.e., a future time), in which case the database will not include such data. As another example, a request for data may be for a type of data not currently stored in the database.

In various embodiments, in response to determining that the requested data is available in the database, the data agency server may send the requested data from the database. The requested data may be sent from the data agency server to the entity that originated the request for data, such as a data client server. In some embodiments, the requested data may be sent in the form of a return response to an API requesting the data. In this manner, the data client server may obtain sensor data from a vehicle via the data agency server.

In various embodiments, in response to determining that the requested data is not available in the database, the data agency server may generate and send a data gathering request to one or more vehicles to obtain the requested data. The data gathering request sent to one or more vehicles may indicate a type of data and a specific location at which to gather the type of data. The data gathering request sent to one or more vehicles may specify information and attributes of collection necessary to satisfy the request for data. The type of data, the specific location, and/or the attribute of collection in the data gathering request may correspond to a type of data, a specific location, and/or an attribute of collection indicated in a request for data received by the data agency server. A data gathering request may set a time for gathering the data that is equal to a current time (e.g., a request for real-time data), or that is after the current time (i.e., a future time).

The data gathering request sent to one or more vehicles may be a message that includes all of the information needed for a vehicle to gather and transmit data sufficient to meet the attributes specified in the data request received by the data agency server. The data gathering request sent to one or more vehicles may indicate a type of data and a specific location at which to gather the type of data. A specific location at which data is to be gathered may be any type of indication of a location, such as a specific geographic point (e.g., a latitude and longitude, another type of coordinate, etc.), an address, a specific geographic place (e.g., a parking lot name, a road intersection name, etc.), a roadway name (e.g., a street name, a highway number, etc.), a geographic area (e.g., a county, a city, a country, a neighborhood, a park, etc.), a geofence (e.g., a radius extending from a coordinate, etc.), etc. The type of requested data may be an indication of the format of the data being requested, such as still image, video, audio, temperature measurement, radar measurement, lidar measurement, acceleration measurement, speed measurement, gas measurement, infrared measurement, ultrasonic measurement, meter reading, etc. In some embodiments, the type of data may be peripheral data that is not associated with driving operations of a vehicle (e.g., a temperature sensor, a gas sensor, etc.).

A data gathering request sent to one or more vehicles may include one or more attributes of collection. An attribute of collection may be an indication of one or more requirements associated with collection of the data being requested. As an example, attributes of collection may include indications of one or more specific sensors to be used in gathering the data (e.g., the data should be gathered using a radar, the data should be gathered using a specific type of camera, the data should be gathered using a gas sensor, etc.). As an example, attributes of collection may include an indication of speed of travel at which the data should be gathered (e.g., a specific mph, a minimum mph, a maximum mph, etc.). As an example, attributes of collection may include an indication of a type of wireless connection to use in transmitting the data (e.g., 5G broadband connection, etc.). As an example, attributes of collection may include an indication of a time or duration over which the data should be gathered (e.g., a specific time period, a starting time, an ending time, etc.). As an example, attributes of collection may include indications of one or more data conditions (e.g., send data associated with a temperature that is above a threshold, send data associated with an acceleration measurement at or above a threshold, send data associated with one or more conditions, etc.). In some embodiments, an attribute of collection may specify or set one or more conditions of the vehicle and/or any sensors utilized in gathering data, such as vehicle speed, vehicle direction, headlight mode, sensor angle, sensor height, sensor mode, engine state, etc. As an example, attributes of collection may include indications of the one or more conditions of the vehicle and/or any sensors utilized in gathering data (e.g., speed and direction during data gathering data, acceleration while gathering data, headlight mode while gathering data, height and angle of a camera recording video, engine “on” or “off” while gathering data, an object to follow while gathering data, a route to follow while gathering data, etc.).

In some embodiments, the data agency server may determine a plurality of vehicles capable of supporting a data gathering request. Vehicles capable of supporting a data gathering request may be vehicles that have the necessary sensors, wireless connection capabilities, operational capabilities (e.g., top speed, etc.), and/or other characteristics to enable the vehicles to gather sensor data in a manner that may fulfill a request for data. In some embodiments, as part of registration with the data agency server, the capabilities of the vehicle (e.g., sensors, sensor status, operational capabilities, available wireless connections, etc.) may be reported by the vehicle to the data agency server. The data agency server may track the capabilities of all registered vehicles and may analyze the capabilities of the registered vehicles to determine a plurality of vehicles capable of supporting a data gathering request.

In various embodiments, vehicles may send their location data (e.g., current GPS coordinates, etc.) to the data agency server, such as periodically. In some embodiments, the vehicles may send their location data in response to an operator or owner of the vehicle authorizing sensor data acquisition. Various embodiments may include systems and methods that enable owners or operators of vehicles to opt-in and opt-out of providing data from their vehicles to the data agency server. For example, on a given drive a vehicle operator may provide an input in a user interface of the vehicle to authorize transmission of acquired data to the data agency server, in response to which the vehicle may begin to periodically send its location to the data agency server. On another drive, the vehicle operator may provide an input in the user interface to de-authorize acquisition and transmission of data to the data agency server, in response to which the vehicle may stop reporting its location to the data agency server. Additionally, when acquisition and transmission of data is not authorized, the vehicle may not respond to requests for data issued by the data agency server. In various embodiments, the data agency server may track vehicles' locations via the location data sent from the vehicles and may maintain a mapping of the locations of all vehicles registered with the data agency server, and in particular all vehicles currently authorized to acquire and transmit sensor data.

In some cases, a data agency server may send a data gathering request that involves the receiving vehicle traveling from the vehicle's current location to a specific location to gather a type of data. To support this, a data agency server may determine current locations of the vehicles determined to be capable of supporting a given data gathering request. For example, the data agency server may determine the current locations of the vehicles based on location data sent from the vehicles. In some embodiments, the data agency server may determine whether any vehicles capable of supporting a given data gathering request are currently located at the specific location indicated in a request for data. For example, the data agency server may compare the current locations of a plurality of vehicles capable of supporting the data gathering request to a specific location indicated in the request for data to determine whether any vehicles are currently located at a specific location indicated in a request for data. One or more vehicles located at or near the specific location (or a location within a threshold distance (e.g., a number of meters, etc.) of the specific location) may be selected to receive the data gathering request. Vehicles located some distance away from the specific location (or beyond a threshold distance (e.g., a number of meters, etc.) of the specific location) may receive the data gathering request. In cases in which no capable vehicle is located at the specific location for gathering data, the data agency server may select from the plurality of capable vehicles at least one vehicle to travel to the specific location. This selection of one or more vehicles to receive the data gathering request may be based on a travel distance or travel time required by capable vehicles, such as selecting capable vehicle(s) that closest to the specific location or that can arrive at the specific location in the shortest time.

In some embodiments, the data gathering request sent to one or more selected vehicles may be a request for continuous acquisition and transmission of data by the vehicle. For example, the request may indicate that the vehicle is to provide sensor data of one or more types continually to the data agency server.

In some embodiments, the data gathering request sent to one or more selected vehicles may be a request for a specific and finite data gathering request (i.e., not a request for continual data gathering). For example, a finite request may be a conditional request instructing the vehicle to gather data at a specific time, for a specific duration, and/or at a specific location. As another example, a finite request may be a conditional request instructing the vehicle to gather data and determine whether a data condition is met before transmitting gathered data to the data agency server. As a specific example, a finite data gathering request may instruct a vehicle to gather acceleration sensor data, radar data, and video data and analyze the gathered data to determine whether an auto accident condition with, or around, the vehicle has occurred (e.g., analyzing the data to detect Doppler effect measurements indicating an accident, images indicating an accident, accelerations indicating an accident, etc.). Such a finite request may indicate that the determination that an auto accident condition with, or around, the vehicle has occurred is a condition for sending gathered data. In response to determining that no auto accident occurred, the vehicle may not send gathered data to the data agency server. In response to determining that an auto accident occurred, gathered data may be sent to the data agency server. Additionally, the data gathering request may indicate subsequent actions for the vehicle to take (e.g., continue uploading video, activate other sensors, take still images in all directions, maintain a copy of the gathered data, etc.). These various parameters regarding gathering and transmitting data may be specified in the attributes of collection included in the data gathering request sent to the selected vehicle.

In various embodiments, a processor of a vehicle may receive a data gathering request from the data agency server. As an example, the data gathering request may be a message indicating a type of data and a specific location at which to gather the type of data, as well as any of the attributes of collection described above.

In various embodiments, the processor of the vehicle may compare the vehicle's current location to the specific location to determine whether the locations match. In response to receiving a data gathering request and determining that the vehicle is not at a specific location indicated in the data gathering request, the processor of the vehicle may drive the vehicle to the specific location. For example, the processor of the vehicle may control an autonomous or semiautonomous driving system to drive the vehicle to the specific location.

In various embodiments, the vehicle may gather the type of data at the specific location indicated in the received data gathering request, and send gathered data to a data agency server. In various embodiments, a processor of a vehicle may gather sensor data according to the indications in the data gathering request. The processor of the vehicle may control one or more sensors of the vehicle to gather the type of data once the vehicle is at the specific location according to any attributes of collection.

In some embodiments, the gathered sensor data may be sent to the data agency server in a message including gathered data, an identifier of the vehicle sending gathered data, and a location indication of the vehicle. In various embodiments, the message sent including gathered data may further include a timestamp indicating the time at which the data was gathered. In various embodiments, gathered data may be sent via wireless communications, such as C-V2X communications (e.g., C2N communications, etc.), etc., to the data agency server. As a specific example, gathered data may be sent from the vehicle to the data agency server via a 5G broadband connection to a wireless network. In various embodiments, the type of wireless connection to establish to send gathered data may be indicated in the data gathering request received by the vehicle, such as in an attribute of collection.

In various embodiments, the data agency server may receive gathered data from at least one vehicle in response to sending the data gathering request to the at least one vehicle. In various embodiments, the data agency server may process gathered data. Processing of received data may be optional (i.e., not necessary in all cases) as some data may be sent directly to an address of the data agency server that may make the vehicle sensor data directly available to a third-party entity, such as a data client server. In such a manner, the data agency server may support live streaming of vehicle sensor data to third party entities, such as data client servers. In various embodiments, gathered data, whether processed or not processed, may be sent from the data agency server to a data client server. In this manner, a third-party entity, such as a data client server, may obtain sensor data from a vehicle.

In various embodiments, processing the sensor data obtained from a vehicle may include validating gathered data, augmenting gathered data, anonymizing gathered data, indexing gathered data, and/or storing gathered data in a database. Validating gathered data may include comparing the type and location of the gathered data to the type and location indicated in a data gathering request. Gathered data that does not match the requested type and location may be determined to be invalid and discarded. Validating may also include verifying a minimum quality of gathered data or applying other threshold checks to gathered data. Augmenting the gathered sensor data may include adding (e.g., in metadata) location information (e.g., a GPS coordinate provided by the vehicle when sending the data, the tracked location of the vehicle stored at the data agency server, etc.) indicating where the data was gathered and time information (e.g., a timestamp from the message including the gathered data, etc.) indicating the time at which the data was gathered. In this manner, augmented gathered data may identify when and where the data was collected. Anonymizing gathered data may include removing information from the data that would enable the identity of the vehicle collecting the data to be determined. Anonymizing may be optional as it may not be required for all types of data or may not be desired by all entities, such as law enforcement organizations, insurance companies, etc. Indexing gathered data may include adding information to the gathered data to identify and make the data searchable by location, by type of data, by attributes of collection associated with the collection of the data itself (e.g., type of sensor used, speed of travel at gathering, type of wireless connection used to transmit the data, time the data was gathered, duration over which the data was gathered, etc.), etc. The data agency server may store the augmented and indexed data in a database, such as a database of vehicle sensor data.

In some embodiments, vehicle owners/operators may be compensated for permitting their vehicles to be tasked to obtain data. For example, as part of processing the gathered data received from a vehicle, the data agency server may compensate an accounted associated with a vehicle providing gathered data. Compensation may be in the form of monetary compensation, reduced cost (or free) network access of data usage, or any other form of compensation. Compensation may be provided by the third-party entity requesting data from the data agency server when data is provided and a portion of that compensation may be credited to an account associated with a vehicle providing gathered data. In this manner, the owner or operator of a vehicle may be compensated for agreeing to provide sensor data from his or her vehicle, which may involve the vehicle traveling to the data gathering location.

Various embodiments may enable sensor data obtained from vehicles to be used in various manners. By using autonomous and semi-autonomous vehicles to gather data, including peripheral data, and send the data to a data agency server for processing, various embodiments may enable a large amount of localized sensor data to be provided by the data agency server to third party entities to assist the entities in performance of their functions and operations.

As an example, a data client server of a police force may send a request for data to a data agency server requesting video data in which a specific vehicle license plate appears, such as to locate a car reported stolen or associated with an Amber alert. In response, the data agency server may analyze its database and return all video showing the vehicle, as well as send out a finite data request to all authorized vehicles having cameras to report back video data in response to detecting the identified license plate in video images. Such capability may enable the police force to track the historical movements of the vehicle from the video based on stored data and locate the vehicle upon data sent to the data agency server by vehicles in response to detecting the license plate.

As another example, a data client server of a police force may send a request for data to a data agency server requesting still images that include the face of a wanted criminal. Such a request may include one or more images of the criminal or facial recognition feature data that may be used by vehicle processor to recognize the criminal. The data agency server may send a data gathering request to registered vehicles to image people, perform facial recognition processing on the images (e.g., using the provided face(s) or facial recognition feature data), and send still image data, as well as image location and time data, to the data agency server in response to detecting the face within images. The gathered still images may be forwarded to the police force by the data agency server to enable the police force to locate the criminal. Alternatively, the data gathering request sent to vehicles may be for images including people, and facial recognition processing may be performed by the data agency server or the police force.

As a further example, a data client server of a law enforcement agency (e.g., FBI, etc.) may send a request for data to a data agency server requesting sensor data useful for detecting explosive material in vehicles. Such a request may indicate a location (e.g., a state) and a time (e.g., current time). The data agency server may send a data gathering request to capable vehicles (i.e., vehicles having a sensor capable of detecting explosives) that are at or near the location (e.g., in the identified state). In response to detecting explosive material, a vehicle may send the data regarding detection of explosive material (e.g., detection levels as well as location and time of detection) to the data agency server, which may provide the data to the agency to enable the agency to find the explosives.

As another example, a data client server of a utility (e.g., a power company, a water company, etc.) may send a request for data for wireless meter data. Vehicles registered with the data agency server may be configured to continually gather wireless meter data from wireless utility meters, such as via Zigbee connections. This wireless meter data may be sent to the data agency server as obtained sensor data. The data agency server may provide the requested wireless meter data from the database to the data client server. In this manner, the utility may be enabled to have continual monitoring of its utility meters and customers may get reports of their utility usage in near real-time.

As another example, a data client server of a road maintenance authorities (e.g., city transportation offices, state highway authorities, etc.) may send a request for data for still image data including certain characteristics such as road defects (e.g., images showing defects in pavement, defects in pavement markings, defective signs, defective traffic lights, defective curbs, road blockages, obstacles in the roadway, etc.) on a specific roadway. The data agency server may search the database for such images. If still image data for the specific roadway is not available in the database, the data agency server may select one or more vehicles to travel to the specified roadway and capture still images of the roadway at a certain speed of travel and to send any identified road defects. The vehicle responding to the request may analyze images (as well as other sensor data) to recognize the requested characteristic (e.g., road defects). A vehicle detecting a road defect may send the captured still image to the data agency server, which may provide the obtained image to the data client server of the road maintenance authority.

As another example, a data client server of a power company may send a request for data for camera data, temperature sensor data, and audible noise data that may indicate a power line sag is occurring. The difference in level between the point of support and the lowest point on the conductor for an overheard transmission line may be referred to as power line sag. Due to thermal expansion, when the line is heated, the conductor may tend to expand which increases the length of the line between two tower supports. The sensor data obtained by vehicles may be analyzed to identify excessive power line sag and gathered data indicating excessive power line sag may be sent to the data client server thereby enabling the power company to monitor its lines via vehicle sensor data.

As another example, a data client server of an emergency management authority (e.g., fire and rescue services, FEMA, the National Flood Insurance Program, etc.) or land management authority (e.g., National Park Service, etc.) may send a data request for a specific location (e.g., national park, road, city, etc.) to gather infrared and temperature sensor data to identify a catastrophic event, such as a wildfire, a flood, etc. The data agency server may search the database and issue data gathering requests to vehicles to search for data indicating emergency conditions or events in the location and provide the data to the data client server.

As another example, a data client server of a gas company may send a data request to the data agency server for gas measurements in a specific county at a current time. The data agency server may send a data gathering request to vehicles with the appropriate gas sensor and the vehicles may drive to the county and gather sensor data to detect with the appropriate gas sensor. The sensor data may be provided to the data client server, which makes the data available to the gas company for identifying leaks in the specific county.

As a still further example, a data client server of an automobile insurance company may send a request for data to a data agency server for auto accident detection starting at the current time. The request for data may indicate the roads and streets to be monitored and the conditions, such as accelerometer readings and Doppler effect measurements that may indicate an auto accident is occurring. Additionally, the request for data may indicate that the vehicle is to provide and maintain recorded video around the vehicle in response to identifying an auto accident. The data agency server may send a data gathering request to one or more vehicles that may drive to, or already be on, the indicated roads and streets. The vehicles may gather accelerometer, radar, and other type data, and in response to determining the conditions for an auto accident are met, may send the video data to the data agency server. The data agency server may provide the video data of the accident to the data client server of the insurance company for use in determining the accident details (e.g., who was at fault, injured parties, etc.).

As yet another example, a data client server may send a request for data for live video data of a building taken from a specific roadway at a set speed of travel below 5 miles per hour and transmitted using a 5G wireless connection. As no capable vehicles may currently be on the specific roadway, the data agency server may select a vehicle with the appropriate camera and ability to establish a 5G wireless connection that is not currently on the specific roadway and send a data gathering request to that vehicle. The data gathering request may also identify a specific address, such as an Internet Protocol (IP) address, of the data agency server to which the vehicle is to send the video data. The vehicle may drive to the specific roadway, gather the video of the building at a speed below 5 miles per hour, and send the video to the specific address via a 5G wireless connection. The data agency server may make the video available to the data client server.

As a further example, a data client server may send a request for data for live video data of a certain location taken by a vehicle parked in a certain direction with a camera of the vehicle set at a certain height. If no capable vehicles are currently be at the certain location, the data agency server may select a vehicle with the appropriate camera and ability to move the camera to the certain height that is not currently parked at the location and send a data gathering request to that vehicle. The data gathering request may identify the certain location, the certain direction to park, the camera to use, and the certain height at which to record video. The vehicle may drive to the certain location, park in the certain direction, adjust the height of the camera, gather the video at the certain height, and send the video. The data agency server may make the video available to the data client server.

As another example, a data client server may send a request for data for service measurements for a certain 5G tower to be taken from a specific highway close to a crowded football stadium at a set speed of travel of 70 mph and transmitted using a 5G wireless connection at a set connection speed. If no capable vehicle is currently on the specific highway, the data agency server may select a vehicle with the appropriate 5G diagnostic and connection speed capabilities and send a data gathering request to that vehicle. The data gathering request may also identify the 5G tower to be checked. The vehicle receiving the request may drive to the specific highway, take service measurements of the 5G tower while traveling at 70 mph, and send the diagnostic results via a 5G wireless connection at the set connection speed. The data agency server may make the diagnostic results of the 5G tower available to the data client server.

As yet another example, a data client server of a highway maintenance authority may send a request for data to a data agency server for data on traffic light visibility at a certain intersection during a certain time of day. The request for data may indicate the intersection to be monitored, the time of day, and that the vehicle is to be stopped at the intersection when using a camera to observe the traffic light in the intersection. The data agency server may send a data gathering request to one or more vehicles, which in turn may drive to (or already be stopped at) the indicated intersection. The vehicles may gather images of the traffic signal at the indicated time of day and send the image data to the data agency server. The data agency server may provide the image data of the traffic signal to the data client server of the highway maintenance authority, which may use the information in determining whether or not sunbeams render the traffic signal difficult to see by occupants of vehicles in the intersection at the certain time of day.

As a further example, a data client server, such as a data client server of an automobile insurance company, a data client server of a police force, etc., may send a request for data to a data agency server for auto accident detection starting at the current time. The request for data may indicate the roads and streets to be monitored and the conditions, such as sharp movement detections, that may indicate an auto accident is occurring. Additionally, the request for data may indicate that the vehicle is to send ten seconds of video recorded by the vehicle prior to an accident and that the vehicle is to record ten seconds of video around the vehicle after the accident in response to identifying an auto accident. The data agency server may send a data gathering request to one or more vehicles that may drive to, or already be on, the indicated roads and streets. The vehicles may gather data associated with movements in their vicinities, and in response to determining that the conditions for an auto accident are met, may send the twenty seconds of video data (e.g., ten seconds from before the accident and ten seconds after the accident) to the data agency server. The data agency server may provide the video data of the accident to the data client server (e.g., the data client server of the automobile insurance company, the data client server of the police force, etc.) for use in determining accident details (e.g., who was at fault, injured parties, etc.).

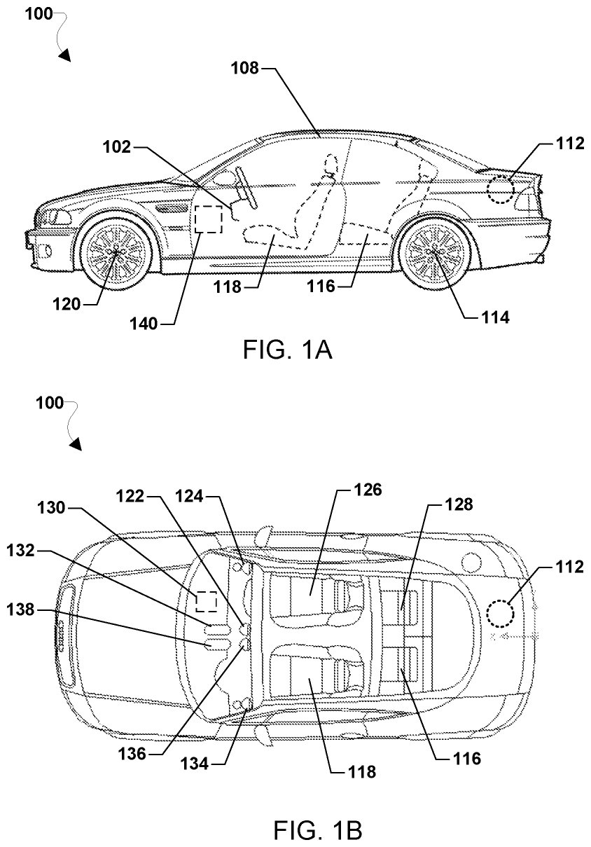

Various embodiments may be implemented within a variety of vehicles configured to obtain sensor data and send vehicle sensor data to a data agency server. An example vehicle 100 is illustrated in FIGS. 1A and 1B. With reference to FIGS. 1A and 1B, a vehicle 100 may include a plurality of sensors 102-138 disposed in or on the vehicle that are used for various purposes, such as purposes involved in autonomous and semiautonomous navigation as well as sensor data regarding objects and people in or on the vehicle 100, purposes not involved in autonomous and semiautonomous navigation, etc. The sensors 102-138 may include one or more of a wide variety of sensors capable of detecting a variety of information, and such information may be useful for navigation and collision avoidance or any other purpose. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, lidar 138, IR sensors, and ultrasonic sensors. The sensors may further include tire pressure sensors 114, 120, humidity sensors, temperature sensors, satellite geo-positioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136. In some embodiments, the control unit 140 may supplement the processing of camera images using distance and relative position (e.g., relative bearing angle) that may be obtained from radar 132 and/or lidar 138 sensors. The control unit 140 may further be configured to control steering, breaking and speed of the vehicle 100 when operating in an autonomous or semiautonomous mode using information regarding other vehicles determined using various embodiments.

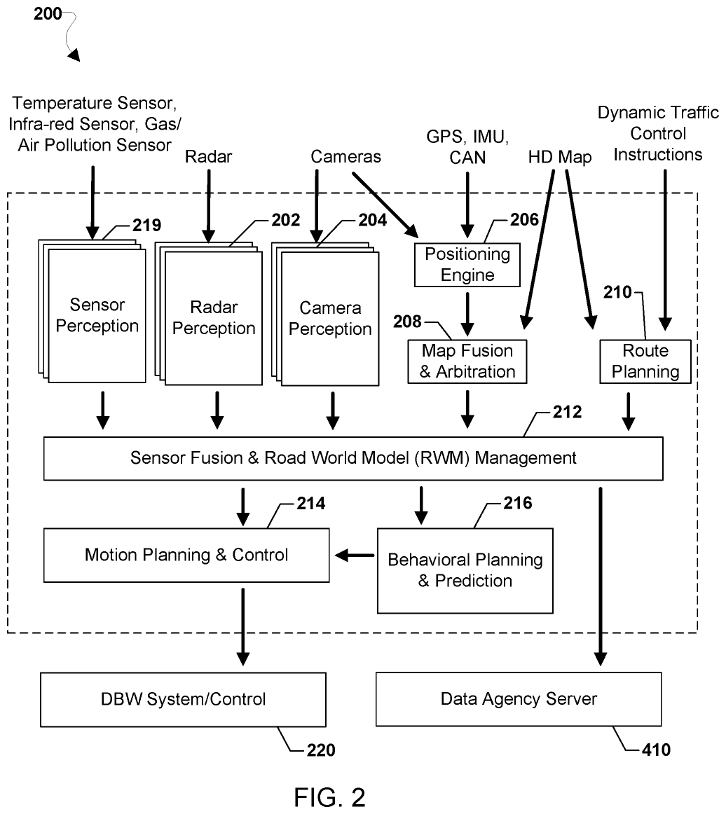

FIG. 2 illustrates an example of subsystems, computational elements, computing devices or units within a vehicle management system 200, which may be utilized within a vehicle 100. With reference to FIGS. 1A-2, in some embodiments, the various computational elements, computing devices or units within vehicle management system 200 may be implemented within a system of interconnected computing devices (i.e., subsystems), that communicate data and commands to each other (e.g., indicated by the arrows in FIG. 2). In other embodiments, the various computational elements, computing devices or units within vehicle management system 200 may be implemented within a single computing device, such as separate threads, processes, algorithms or computational elements. Therefore, each subsystem/computational element illustrated in FIG. 2 is also generally referred to herein as “layer” within a computational “stack” that constitutes the vehicle management system 200. However, the use of the terms layer and stack in describing various embodiments are not intended to imply or require that the corresponding functionality is implemented within a single autonomous (or semi-autonomous) vehicle control system computing device, although that is a potential implementation embodiment. Rather the use of the term “layer” is intended to encompass subsystems with independent processors, computational elements (e.g., threads, algorithms, subroutines, etc.) running in one or more computing devices, and combinations of subsystems and computational elements.

In various embodiments, the vehicle management system stack 200 may include a radar perception layer 202, a camera perception layer 204, a positioning engine layer 206, a map fusion and arbitration layer 208, a route planning layer 210, sensor fusion and road world model (RWM) management layer 212, motion planning and control layer 214, behavioral planning and prediction layer 216, and another sensor perception layer 219. The layers 202-219 are merely examples of some layers in one example configuration of the vehicle management system stack 200 and in other configurations other layers may be included, such as additional layers for other perception sensors (e.g., LIDAR perception layer, etc.), additional layers for planning and/or control, additional layers for modeling, etc., and/or certain of the layers 202-219 may be excluded from the vehicle management system stack 200. Each of the layers 202-219 may exchange data, computational results and commands as illustrated by the arrows in FIG. 2. Further, the vehicle management system stack 200 may receive and process data from sensors (e.g., radar, lidar, cameras, inertial measurement units (IMU) etc.), navigation systems (e.g., GPS receivers, IMUs, etc.), vehicle networks (e.g., Controller Area Network (CAN) bus), and databases in memory (e.g., digital map data). The vehicle management system stack 200 may output vehicle control commands or signals to the drive by wire (DBW) system/control unit 220, which is a system, subsystem or computing device that interfaces directly with vehicle steering, throttle and brake controls.

The radar perception layer 202 may receive data from one or more detection and ranging sensors, such as radar (e.g., 132) and/or lidar (e.g., 138), and process the data to recognize and determine locations of other vehicles and objects within a vicinity of the vehicle 100. The radar perception layer 202 may include use of neural network processing and artificial intelligence methods to recognize objects and vehicles, and pass such information on to the sensor fusion and RWM management layer 212.

The camera perception layer 204 may receive data from one or more cameras, such as cameras (e.g., 122, 136), and process the data to recognize and determine locations of other vehicles and objects within a vicinity of the vehicle 100. The camera perception layer 204 may include use of neural network processing and artificial intelligence methods to recognize objects and vehicles, and pass such information on to the sensor fusion and RWM management layer 212.

The sensor perception layer 219 may receive data from one or more sensors, such as a one or more temperature sensors, one or more infra-red sensors, one or more gas/air pollution sensors, and/or any other type of sensor (e.g., any of sensors 102-138), and process the data to recognize and determine one or more states of the environment in the vicinity of the vehicle 100. The sensor perception layer 219 may include use of neural network processing and artificial intelligence methods to recognize states of the environment, and pass such information on to the sensor fusion and RWM management layer 212.

The positioning engine layer 206 may receive data from various sensors and process the data to determine a position of the vehicle 100. The various sensors may include, but is not limited to, GPS sensor, an IMU, and/or other sensors connected via a CAN bus. The positioning engine layer 206 may also utilize inputs from one or more cameras, such as cameras (e.g., 122, 136) and/or any other available sensor, such as radars, LIDARs, etc.

The map fusion and arbitration layer 208 may access data within a high definition (HD) map database and receive output received from the positioning engine layer 206 and process the data to further determine the position of the vehicle 100 within the map, such as location within a lane of traffic, position within a street map, etc. The HD map database may be stored in a memory (e.g., memory 166). For example, the map fusion and arbitration layer 208 may convert latitude and longitude information from GPS into locations within a surface map of roads contained in the HD map database. GPS position fixes include errors, so the map fusion and arbitration layer 208 may function to determine a best guess location of the vehicle within a roadway based upon an arbitration between the GPS coordinates and the HD map data. For example, while GPS coordinates may place the vehicle near the middle of a two-lane road in the HD map, the map fusion and arbitration layer 208 may determine from the direction of travel that the vehicle is most likely aligned with the travel lane consistent with the direction of travel. The map fusion and arbitration layer 208 may pass map-based location information to the sensor fusion and RWM management layer 212.

The route planning layer 210 may utilize the HD map, dynamic traffic control instructions from a traffic management system, and/or other inputs, such as from an operator or dispatcher, to plan a route to be followed by the vehicle 100 to a particular destination. As an example, the route planning layer 210 may use a specific location indicated for obtaining sensor data in a received data gathering request plan a route from a current location of the vehicle to the specific location. The route planning layer 210 may pass map-based location information and/or the dynamic traffic control instructions to the sensor fusion and RWM management layer 212. However, the use of a prior map by other layers, such as the sensor fusion and RWM management layer 212, etc., is not required. For example, other stacks may operate and/or control the vehicle based on perceptual data alone without a provided map, constructing lanes, boundaries, and the notion of a local map as perceptual data is received.

The sensor fusion and RWM management layer 212 may receive data and outputs produced by the radar perception layer 202, camera perception layer 204, sensor perception layer 219, map fusion and arbitration layer 208, and route planning layer 210, and use some or all of such inputs to estimate or refine the location and state of the vehicle 100 in relation to the road, other vehicles on the road, and other objects within a vicinity of the vehicle 100. For example, the sensor fusion and RWM management layer 212 may combine imagery data from the camera perception layer 204 with arbitrated map location information from the map fusion and arbitration layer 208 to refine the determined position of the vehicle within a lane of traffic. As another example, the sensor fusion and RWM management layer 212 may combine object recognition and imagery data from the camera perception layer 204 with object detection and ranging data from the radar perception layer 202 to determine and refine the relative position of other vehicles and objects in the vicinity of the vehicle. As another example, the sensor fusion and RWM management layer 212 may receive information from vehicle-to-vehicle (V2V) communications (such as via the CAN bus) regarding other vehicle positions and directions of travel, and combine that information with information from the radar perception layer 202 and the camera perception layer 204 to refine the locations and motions of other vehicles.

As a further example, the sensor fusion and RWM management layer 212 may use dynamic traffic control instructions directing the vehicle 100 to change speed, lane, direction of travel, or other navigational element(s), and combine that information with other received information to determine refined location and state information. The sensor fusion and RWM management layer 212 may output the refined location and state information of the vehicle 100, as well as refined location and state information of other vehicles and objects in the vicinity of the vehicle 100, to the motion planning and control layer 214, the behavior planning and prediction layer 216, and/or a data agency server 410 (via wireless communications, such as through C-V2X connections, other wireless connections, etc.).

As a still further example, the sensor fusion and RWM management layer 212 may monitor perception data from various sensors, such as perception data from a radar perception layer 202, camera perception layer 204, other perception layer, etc., and/or data from one or more sensors themselves to analyze conditions in the vehicle sensor data. The sensor fusion and RWM management layer 212 may be configured to detect conditions in the sensor data, such as sensor measurements being at, above, or below a threshold, certain types of sensor measurements occurring, etc., and may output the sensor data as part of the refined location and state information of the vehicle 100 provided to the behavior planning and prediction layer 216, and/or a data agency server 410 (via wireless communications, such as through C-V2X connections, other wireless connections, etc.).

The refined location and state information may include detailed information associated with the vehicle and the vehicle owner and/or operator, such as the vehicle specifications (e.g., size, weight, color, on board sensor types, etc.), position, speed, acceleration, direction of travel, attitude, orientation, destination, fuel/power level(s), emergency status (e.g., is the vehicle an emergency vehicle or private individual in an emergency), restrictions (e.g., heavy/wide load, turning restrictions, high occupancy vehicle (HOV) authorization, etc.), capabilities, (e.g., all-wheel drive, four-wheel drive, snow tires, chains, connection types supported, on board sensor operating statuses, on board sensor resolution levels, etc.) of the vehicle, equipment problems (e.g., low tire pressure, weak breaks, sensor outages, etc.), owner/operator travel preferences (e.g., preferred lane, roads, routes, and/or destinations, preference to avoid tolls or highways, preference for the fastest route, etc.), preference to provide sensor data to the data agency server 410, and/or owner/operator identification information.

The behavioral planning and prediction layer 216 of the autonomous vehicle system stack 200 may use the refined location and state information of the vehicle 100 and location and state information of other vehicles and objects output from the sensor fusion and RWM management layer 212 to predict future behaviors of other vehicles and/or objects. For example, the behavioral planning and prediction layer 216 may use such information to predict future relative positions of other vehicles in the vicinity of the vehicle based on own vehicle position and velocity and other vehicle positions and velocity. Such predictions may take into account information from the HD map and route planning to anticipate changes in relative vehicle positions as host and other vehicles follow the roadway. The behavioral planning and prediction layer 216 may output other vehicle and object behavior and location predictions to the motion planning and control layer 214.

Additionally, object behavior as well as location predictions from the behavior planning and prediction layer 216 may plan and generate control signals for controlling the motion of the vehicle 100. For example, based on route planning information, refined location in the roadway information, and relative locations and motions of other vehicles, the behavior planning and prediction layer 216 may determine that the vehicle 100 needs to change lanes and accelerate, such as to maintain or achieve minimum spacing from other vehicles, and/or prepare for a turn or exit. As a result, the behavior planning and prediction layer 216 may calculate or otherwise determine a steering angle for the wheels and a change to the throttle to be commanded to motion planning and control layer 214 and the DBW system/control unit 220, along with various parameters that may be necessary to effectuate such lane change and accelerate. One such parameter may be a computed steering wheel command angle.

The motion planning and control layer 214 may receive data and information outputs from the sensor fusion and RWM management layer 212 and other vehicle and object behavior as well as location predictions from the behavior planning and prediction layer 216, and use this information to plan and generate control signals for controlling the motion of the vehicle 100 and to verify that such control signals meet safety requirements for the vehicle 100. For example, based on route planning information, refined location in the roadway information, and relative locations and motions of other vehicles, the motion planning and control layer 214 may verify and pass various control commands or instructions to the DBW system/control unit 220.

The DBW system/control unit 220 may receive the commands or instructions from the motion planning and control layer 214 and translate such information into mechanical control signals for controlling wheel angle, brake and throttle of the vehicle 100. For example, DBW system/control unit 220 may respond to the computed steering wheel command angle by sending corresponding control signals to the steering wheel controller.

In various embodiments, the vehicle management system stack 200 may include functionality that performs safety checks or oversight of various commands, planning or other decisions of various layers that could impact vehicle and occupant safety. Such safety check or oversight functionality may be implemented within a dedicated layer (not shown) or distributed among various layers and included as part of the functionality. In some embodiments, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction layer 216 (or in a separate layer not shown) may determine the current or future separate distance between another vehicle (as refined by the sensor fusion and RWM management layer 212) and the vehicle (e.g., based on the world model refined by the sensor fusion and RWM management layer 212), compare that separation distance to a safe separation distance parameter stored in memory, and issue instructions to the motion planning and control layer 214 to speed up, slow down or turn if the current or predicted separation distance violates the safe separation distance parameter. As another example, safety or oversight functionality in the motion planning and control layer 214 (or a separate layer not shown) may compare a determined or commanded steering wheel command angle to a safe wheel angle limit or parameter, and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

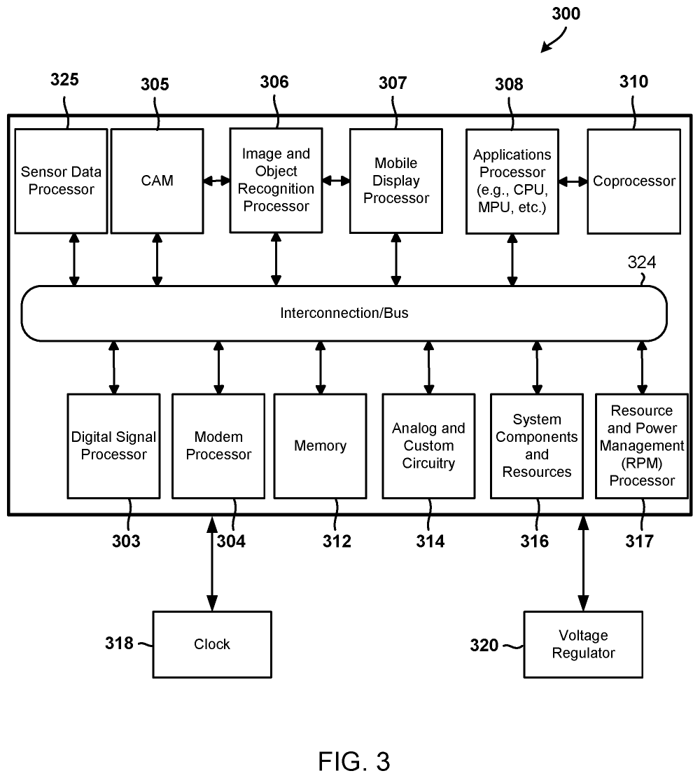

FIG. 3 illustrates an example system-on-chip (SOC) architecture of a processing device SOC 300 suitable for implementing various embodiments in vehicles. With reference to FIGS. 1A-3, the processing device SOC 300 may include a number of heterogeneous processors, such as a digital signal processor (DSP) 303, a modem processor 304, an image and object recognition processor 306, a mobile display processor 307, an applications processor 308, sensor data processor 325, and a resource and power management (RPM) processor 317. The processing device SOC 300 may also include one or more coprocessors 310 (e.g., vector co-processor) connected to one or more of the heterogeneous processors 303, 304, 306, 307, 308, 317, 325. Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras 122, 136 (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras (e.g., 122, 136) via the CAM 305 to recognize and/or identify other vehicles, and otherwise perform functions of the camera perception layer (e.g., 204) as described. In some embodiments, the processor 306 may be configured to process radar or lidar data and perform functions of the radar perception layer (e.g., 202) as described. In some embodiments, the processor 306 may be configured to process any type of sensor data, such as temperature sensor data, infra-red sensor data, gas/air pollution sensor data, etc., and perform functions to operate as a perception layer (e.g., 219) for that sensor data. In some embodiments, the sensor data processor 325 may be configured with processor-executable instructions and/or specialized hardware configured to perform environmental state detection and recognition analyses involved in various embodiments. For example, the sensor data processor 325 may be configured to perform operations of sensor data processing on data received from sensors (e.g., any one or more of sensors 102-138 or any other type of sensors) to recognize and/or identify environmental states (e.g., current temperature, presence of a fire, presence of gas or other pollution, etc.), and otherwise perform functions of the sensor perception layer (e.g., 219) as described.

The system components and resources 316, analog and custom circuitry 314, and/or CAM 305 may include circuitry to interface with peripheral devices, such as cameras (e.g., 122, 136), radar (e.g., 132), lidar (e.g., 138), electronic displays, wireless communication devices, external memory chips, any type of sensor, etc. The processors 303, 304, 306, 307, 308, 325 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communication with a telephone network (e.g., through a network transceiver 180), the Internet, and/or a network server (e.g., 210) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, gas sensors, GPS receivers, communications circuitry (e.g., Bluetooth®, WLAN, Wi-Fi, Zigbee, etc.), and other well-known components of modern electronic devices.

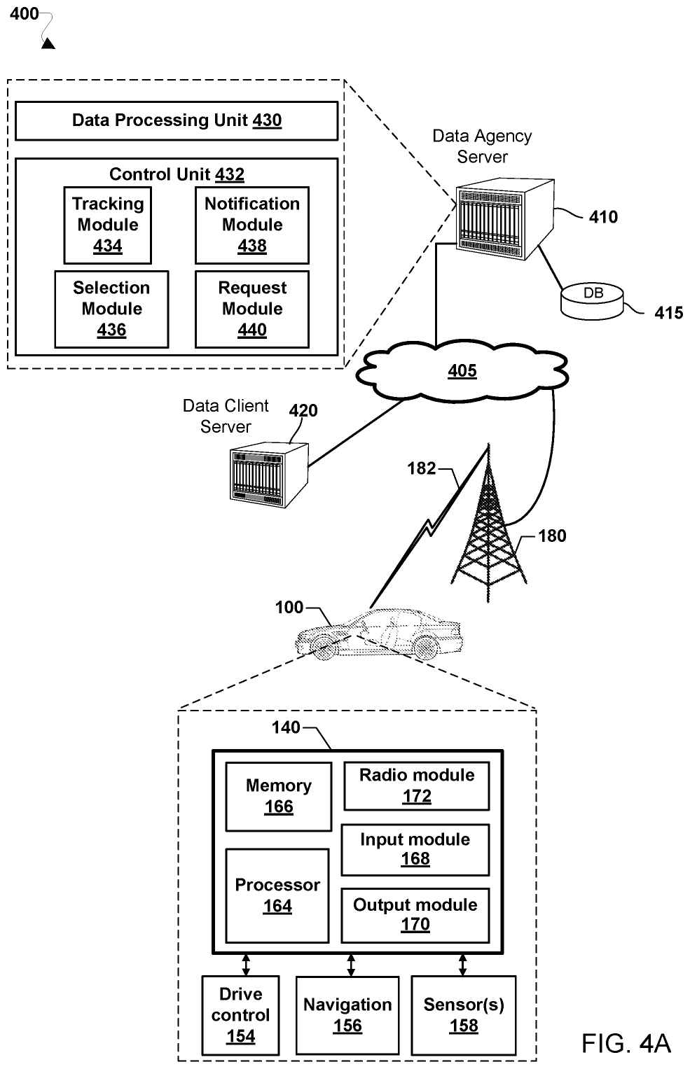

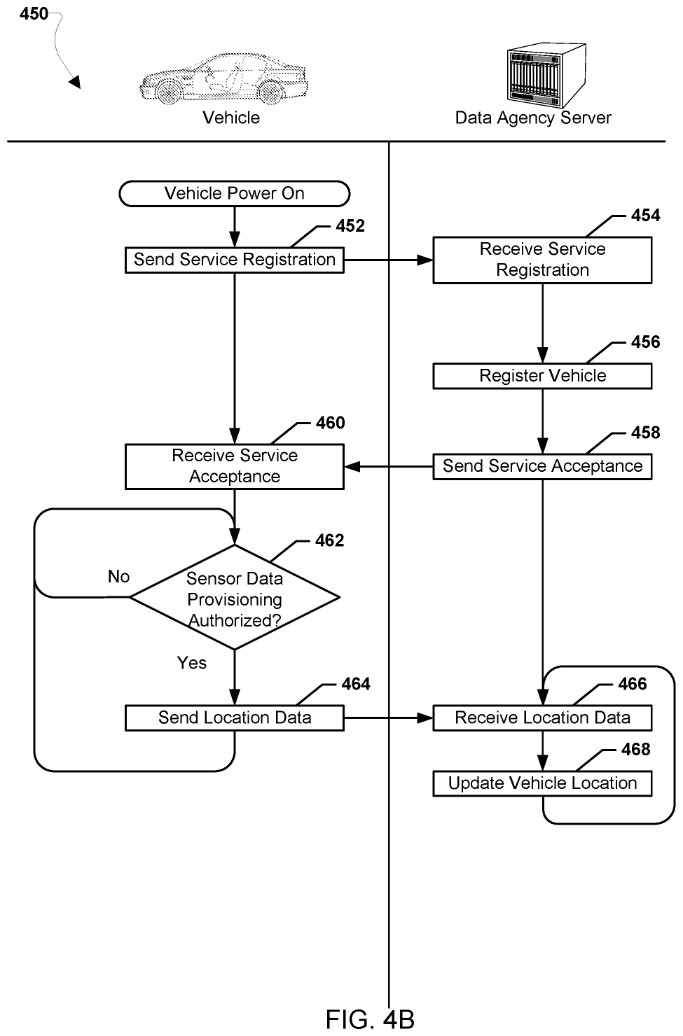

FIG. 4A is a component block diagram illustrating example elements a vehicle data system 400 suitable for implementing various embodiments. With reference to FIGS. 1A-4A, the system 400 may include a data agency server 410 configured to communicate with the vehicle 100. The vehicle 100 may obtain sensor data from one or more of its sensors and transmit sensor data to the data agency server 410.

The vehicle 100 may include a control unit 140, which may include various circuits and devices used to control the operation of the vehicle 100. The control unit 140 may be coupled to and configured to control drive control components 154, navigation components 156, and one or more vehicle sensors 158 of the vehicle 100.

As used herein, the terms “component,” “system,” “unit,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The control unit 140 may include a processor 164 configured with processor-executable instructions to control maneuvering, navigation, and other operations of the vehicle 100, including operations of various embodiments. The processor 164 may be coupled to a memory 166. The control unit 140 may include an input module 168, an output module 170, and a radio module 172.

The radio module 172 may be configured for wireless communication. The radio module 172 may exchange signals 182 (e.g., command signals for controlling maneuvering, signals from navigation facilities, wireless signals including gathered sensor data, signals including requests for data, etc.) with a network transceiver 180, and may provide the signals 182 to the processor 164 and/or the navigation components 156. The signals 182 may be used by the radio module 172 to transmit refined location and state information and/or send gathered data to the data agency server 410. In various embodiments, the exchanged signals 182 may be established using V2N type connections in mobile broadband systems and technologies, such as 3G (e.g., GSM EDGE, CDMA, etc.), 4G (e.g., LTE, LTE-Advanced, mobile WiMAX, etc.), 5G (e.g., 5G NR, etc.). The radio module 172 may additional exchange signals (e.g., Bluetooth®, WLAN, Wi-Fi, Zigbee, etc.) with other wireless devices, such as smart meters, other vehicles, etc., to gather sensor data from those other devices.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), and other similar devices.

The control unit 140 may be coupled to the navigation components 156, and may receive data from the navigation components 156 and be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals (e.g., instructions from intelligent and adaptive traffic signs) from radio nodes, such as Wi-Fi access points, cellular network sites, radio station, remote computing devices, other vehicles, etc. Through control of the drive control components 154, the processor 164 may control the vehicle 100 to navigate and maneuver. In this manner, the processor 164 may drive the vehicle 100 from one location to another location.

The control unit 140 may be coupled to one or more vehicle sensors 158. The sensor(s) 158 may include the sensors 102-138 as described (as well as any other described sensor), and may the configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

In some embodiments, the control unit 140 and network transceiver 180 may communicate similar in one or more aspects to (or incorporated into) the functionality of a cellular IoT (CIoT) base station (C-BS), a NodeB, an evolved NodeB (eNodeB), radio access network (RAN) access node, a radio network controller (RNC), a base station (BS), a macro cell, a macro node, a Home eNB (HeNB), a femto cell, a femto node, a pico node, or some other suitable entity based on the radio technology used to establish the network-to-device links between the network transceiver 180 and the control unit 140. The network transceiver 180 may be in communication with respective routers that may connect to the network 405 (e.g., 3G network, 4G network, 5G network, core network, Internet, combinations of the same, etc.). Using the connections to the network transceiver 180, the control unit 140 may exchange data with the network 405 as well as devices connected to the network 405, such as the data agency server 410 or any other communication device connected to the network 405.

The data agency server 410 may be configured to communicate with the vehicle 100 over the network 405. Via the connections to the network 405, the data agency server 410 may be configured to obtain sensor data from the vehicle 100. The data agency server 410 may store sensor data from the vehicle 100 in a database 415 of vehicle sensor data. The data agency server 410 may be configured to communicate with computing devices of third-party entities (e.g., road maintenance authorities, emergency management authorities, utility companies, police forces, insurance companies, etc.), such as data client servers 420 operated by the third-party entities, over the network 405 (e.g., 3G network, 4G network, 5G network, core network, Internet, combinations of the same, etc.). The data agency server 410 may exchange communications with the data client server 420 to provide sensor data obtained from the vehicle 100 to the data client server 420. As a specific example, a data client server 420 may interface with the data agency server 410 via an API to obtain vehicle sensor data from the data agency server 410 and/or the database 415. In various embodiments, a data client server 420 may send requests for data to the data agency server 410 to obtain vehicle sensor data from the data agency server 410 and/or the database 415.

In various embodiments, the database 415 may be indexed and searchable by the data agency server 410. For example, vehicle sensor data in the database 415 may be indexed by location at which data was gathered, by type of data, by attributes of collection associated with the collection of the data itself (e.g., type of sensor used, speed of travel at gathering, type of wireless connection used to transmit the data, time the data was gathered, duration over which the data was gathered, etc.), by vehicle collecting the data, etc. In various embodiments, the vehicle sensor data in the database 415 may be augmented with location information (e.g., a GPS coordinate, etc.) indicating the location at which the data was collected and time information (e.g., a timestamp, etc.) indicating the time at which the data was collected. In various embodiments, the vehicle sensor data in the database 415 may be anonymized such that the identity of the vehicle that collected the data cannot be determined from the data.

In various embodiments, the data agency server 410 may include a data processing unit 430, which may include various circuits and devices used to process data received by the data agency server 410. Processing data received by the data agency server 410 may include providing data access, removing redundant data from the database, performing data analysis and mining operations, augmenting sensor data, validating sensor data, and any other processing operations that may be performed on obtained sensor data from a vehicle, such as vehicle 100. The data processing unit 430 may further communicate sensor data from the database 415 and/or from the vehicles themselves, such as vehicle 100, to the data client server 420 in response to requests for data. The data agency server may include a control unit 432, which may include various circuits and devices used to obtain sensor data from vehicles, such as vehicle 100. The control unit 432 may interface with the data processing unit 430 and/or the database 415. The control unit 432 may include a tracking module 434, selection module 436, notification module 438, and request module 440. The tracking module 434 may be configured to track the locations of the vehicles providing sensor data to the data agency server 410, such as vehicle 100. The notification module 438 may be configured to provide requests for data to vehicles to obtain sensor data for the data agency server 410. The selection module 436 may be configured to select vehicles to provide sensor data to the data agency server 410, such as vehicle 100. The request module 440 may be configured to generate requests for data in response to requests for data received by the data agency server 410.

While the data processing unit 430 and control unit 432 are described as being and/or including separate components, in some embodiments some or all of the components (e.g., data processing unit 430, control unit 432, tracking module 434, selection module 436, notification module 438, and request module 440) may be integrated in a single device or module, such as a SOC processing device. Such an SOC processing device may be configured for use servers and be configured, such as with processor-executable instructions executing in the data processing unit and/or control unit 432, to perform operations of various embodiments when installed in a server.

FIG. 4B illustrates a method 450 for registering a vehicle for acquisition and transmission of data according to various aspects. With reference to FIGS. 1A-4B, the method 450 may be implemented in hardware components and/or software components of a data agency server (e.g., data agency server 410). Additionally, the method 450 may be implemented in a processor (e.g., 164), a processing device (e.g., 300), and/or a control unit (e.g., 140) (variously referred to as a “processor”) of a vehicle (e.g., 100). In some embodiments, the method 450 may be performed by one or more layers within a vehicle control system stack 200. In other embodiments, the method 450 may be performed by a processor independently from, but in conjunction with, the vehicle control system stack 200. For example, the method 450 may be implemented as a stand-alone software module or within dedicated hardware that monitors data and commands from/within the vehicle control system stack 200 and is configured to take actions and store data as described. In some embodiments, the operations of method 450 may be performed after the vehicle is powered on.

In block 452, the processor of the vehicle may send a service registration to the data agency server. The service registration may be a message notifying the data agency server that the vehicle may be available and/or is authorized for service obtaining sensor data. In some embodiments, as part of registration with the data agency server, the capabilities of the vehicle (e.g., sensors, sensor status, operational capabilities, available wireless connections, etc.) may be reported by the vehicle to the data agency server in the service registration. Additionally, the service registration may indicate an account associated with the vehicle for purposes of receiving compensation. The service registration may be sent in response to a vehicle operator or owner enabling a sensor data acquisition and transmission feature of the vehicle, such as through an interaction with a graphical user interface of the vehicle on a vehicle display.

In block 454, data agency server may receive the service registration. In block 456, the data agency server may register the vehicle. Registering the vehicle may include tracking the capabilities of the vehicle and making the vehicle available for receiving requests for data. In block 458, the data agency server may send a service acceptance to the vehicle, and in block 460 the processor of the vehicle may receive the service acceptance. The service acceptance may be an indication that the vehicle is registered to provide sensor data to the data agency server.

In determination block 462, the processor of the vehicle may determine whether sensor data acquisition and transmission is authorized. Providing sensor data to the data agency server may be optional, and owners/operators of vehicles may selectively opt in and out of providing data in some embodiments. For example, when an owner/operator chooses to make his or her vehicle available for gathering sensor data, the owner/operator may touch or press a button in a graphical user interface of the vehicle to turn sensor data acquisition and transmission “on.” Similarly, when the owner/operator chooses to not make his or her vehicle available for gathering sensor data, the owner/operator may touch or press a button in the graphical user interface to turn sensor data acquisition and transmission “off” The status of the user selection, which may be stored as a state or flag in a register of memory, may indicate whether sensor data acquisition and transmission is or is not authorized at a given time.

In response to determining that sensor data acquisition and transmission is not authorized (i.e., determination block 462=“No”), the vehicle processor may continue to determine whether sensor data acquisition and transmission is authorized in determination block 462.

In response to determining that sensor data acquisition and transmission is authorized (i.e., determination block 462=“Yes”), the vehicle processor may send location data to the data agency server in block 464. Examples of location data may include current GPS coordinates, current state, current country, etc. As a specific example, on a given drive a vehicle operator may touch or press a button in the graphical user interface of the vehicle to authorize data acquisition and transmission to the data agency server and the vehicle may begin to periodically send its location to the data agency server. On another given drive, the vehicle operator may touch or press a button in the graphical user interface to de-authorize data acquisition and transmission to the data agency server and the vehicle may stop reporting its location to the data agency server.

In block 466, the data agency server may receive the location data. In block 468, the data agency server may update the vehicle location. In various embodiments, the data agency server may track vehicles' locations via the location data sent from the vehicles and may maintain a mapping of the locations of all vehicles registered with the data agency server.

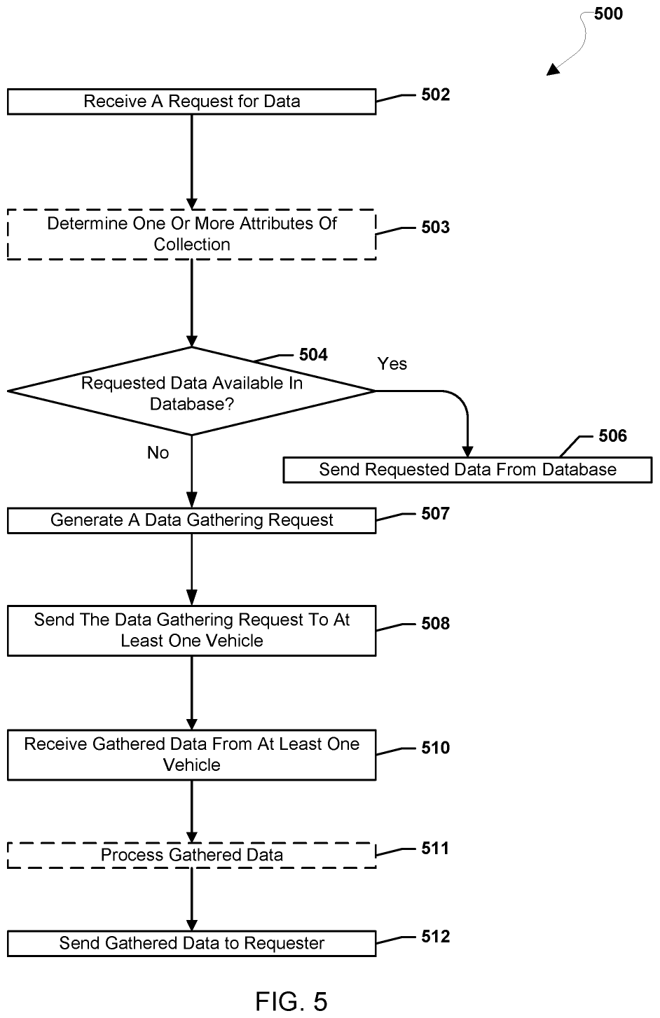

FIG. 5 illustrates a method 500 for obtaining sensor data from a vehicle according to various aspects. With reference to FIGS. 1A-5, the method 500 may be implemented in hardware components and/or software components of a data agency server (e.g., data agency server 410). In various embodiments, the operations of method 500 may be performed in conjunction with or following operations of the method 450.

In block 502, the data agency server may receive a request for data. In some embodiments, the request for data may be received from a data client server (e.g., data client server 420). For example, the request for data may be received from a data client server via an API. A request for data may be a request by the data client server to obtain vehicle sensor data from the data agency server. For example, the request for data may be a message requesting vehicle sensor data from the data agency server.

In various embodiments, the request for data may indicate a specific location at which data is to be gathered and/or a type of requested data. A specific location at which data is to be gathered may be any type of indication of a location, such as a specific geographic point (e.g., a latitude and longitude, another type of coordinate, etc.), a specific geographic place (e.g., a parking lot name, a road intersection name, etc.), an address, a roadway name (e.g., a street name, a highway number, etc.), a geographic area (e.g., a county, a city, a country, a neighborhood, a park, etc.), a geofence (e.g., a radius extending from a coordinate, etc.), etc. The type of requested data may be an indication of the format of the data being requested, such as still image, video, audio, temperature measurement, radar measurement, lidar measurement, acceleration measurement, speed measurement, gas measurement, infrared measurement, ultrasonic measurement, meter reading, etc. In some embodiments, the type of data may be peripheral data that is not associated with driving operations of a vehicle. For example, the type of data may be data collected by a sensor not supporting autonomous or semiautonomous driving (e.g., a temperature sensor, a gas sensor, etc.).

In various embodiments, the request for data may additionally indicate an attribute of collection. An attribute of collection may be an indication of one or more requirements associated with collection of the data being requested. In some embodiments, an attribute of collection may specify or set one or more conditions of the vehicle and/or any sensors utilized in gathering data, such as vehicle speed, vehicle direction, headlight mode, sensor angle, sensor height, sensor mode, engine state, etc. A request for data may include one or more attributes of collection. As an example, attributes of collection may include indications of one or more specific sensors to be used in gathering the data (e.g., the data should be gathered using a radar, the data should be gathered using a specific type of camera, the data should be gathered using a gas sensor, etc.). As an example, attributes of collection may include an indication of speed of travel at which the data should be gathered (e.g., a specific mph, a minimum mph, a maximum mph, etc.). As an example, attributes of collection may include an indication of a type of wireless connection to use in transmitting the data (e.g., 5G broadband connection, etc.). As an example, attributes of collection may include an indication of a time or duration over which the data should be gathered (e.g., a specific time period, a starting time, an ending time, etc.). As an example, attributes of collection may include indications of one or more data conditions (e.g., send data associated with a temperature that is above a threshold, send data associated with an acceleration measurement at or above a threshold, send data associated with one or more conditions, etc.). As an example, attributes of collection may include indications of the one or more conditions of the vehicle and/or any sensors utilized in gathering data. Non-limiting examples of such indications may include: an indication of a specific speed and direction for the vehicle to be traveling during data gathering data; an indication a specific acceleration for the vehicle to be experiencing while gathering data; an indication of whether to have the headlight mode be “on” or “off” while gathering data; an indication of a height and angle of a camera to use in recording video; an indication of whether to have the engine be “on” or “off” while gathering data; an indication to follow a specific object while gathering data; an indication to follow a specific route while gathering data; etc. Attributes of collection may enable third party client devices, such as data client servers, and the entities that control those devices to tailor requests for vehicle data.

In optional block 503, the data agency server may determine one or more attributes of collection. For example, a data agency server may determine one or more attributes of collection by parsing a request for data. Determining one or more attributes of collection may be optional as all requests for data may not include attributes of collection.

In determination block 504, the data agency server may determine whether the requested data is available in a database (e.g., database 415). In some embodiments, a data agency server may determine whether requested data is available in a database, such as a database of vehicle sensor data, in response to receiving a request for data. In some embodiments, a data agency server may determine whether requested data is available in a database, such as a database of vehicle sensor data, in response to determining one or more attributes of collection.

In various embodiments, the data agency server may determine whether requested data is available in a database, such as a database of vehicle sensor data by searching the database to find any data that meets all requirements of the request for data (e.g., gathered at the specific location, of the type of requested data, and, when included, having all attributes of collection in the received request for data). Searching the database may include high level search operations, such as to merely compare index information for data to a search criteria, etc., and/or granular search operations, such as to analyze the data itself to detect attributes within the data itself matching a search criteria (e.g., to detect a specific vehicle license plate in image data, to detect a specific face by facial recognition in image data, to detect the presence of explosive materials, to detect a road defect, to detect power line power line sag, to detect a fire, to detect a flood, to detect an auto accident, etc.). As a specific example, the data agency server may determine whether any sensor data of a type requested (e.g., image, audio, radar, temperature, etc.) gathered in a specific city is available in the database. As another specific example, the data agency server may determine whether any infrared and temperature sensor data in the database indicates the presence of a wildfire in a national park. As another specific example, the data agency server may determine whether any sensor data in the database indicates the presence of a flood in a state. As another specific example, the data agency server may determine whether any camera, temperature sensor, and/or audible noise data in the database indicates a power line is sagging in a city. As another specific example, the data agency server may determine whether any camera image data in the database indicates a road defect is present on a city street, such as defects in pavement, defects in pavement markings, defective signs, defective lights, defective curbs, an obstacle in the street (e.g., a fallen tree, exploded tire, etc.), etc. As another specific example, the data agency server may determine whether any sensor data in the database indicates explosive materials are hidden in any vehicles in a city. As another specific example, the data agency server may determine whether any camera data of a specific intersection at a specific time is available. As another specific example, the data agency server may determine whether any wireless utility meter readings are available in the database for a given city. Finding data that matches all the requirements of the request for data may indicate that the requested data is available in the database. Finding no data that matches all the requirements of the request for data may indicate that the requested data is not available in the database.

In response to determining that the requested data is available in the database (i.e., determination block 504=“Yes”), the data agency server may send the requested data from the database in block 506. The requested data may be sent from the data agency server to the entity that originated the request for data, such as a data client server. In this manner, the data client server may obtain sensor data from a vehicle via the data agency server.

In response to determining that the requested data is not available in the database (i.e., determination block 504=“No”), the data agency server may generate a data gathering request in block 507. In various embodiments, the data gathering request may be a request to have data that is not currently available in a database, such as a database of vehicle sensor data, obtained by one or more vehicles. For example, a data gathering request may include an attribute of collection that sets a time for gathering the data that is equal to a current time (e.g., a request for real-time data), or that is after the current time, and the database may not include such data. As another example, a data gathering request may be for a type of data not currently stored in the database. In response, the data agency server may generate a data gathering request to obtain vehicle data comporting with the request for data.

In various embodiments, the data gathering request may indicate a type of data and a specific location at which to gather the type of data. As an example, the data gathering request may be a message indicating a type of data and a specific location at which to gather the type of data. In various embodiments, the data gathering request may further indicate an attribute of collection. The type of data, the specific location, and/or the attribute of collection in the data gathering request may correspond to a type of data, a specific location, and/or an attribute of collection indicated in a request for data received by the data agency server. A specific location at which data is to be gathered may be any type of indication of a location, such as a specific geographic point (e.g., a latitude and longitude, another type of coordinate, etc.), a specific geographic place (e.g., a parking lot name, a road intersection name, etc.), an address, a roadway name (e.g., a street name, a highway number, etc.), a geographic area (e.g., a county, a city, a country, a neighborhood, a park, etc.), a geofence (e.g., a radius extending from a coordinate, etc.), etc. The type of requested data may be an indication of the format of the data being requested, such as still image, video, audio, temperature measurement, radar measurement, lidar measurement, acceleration measurement, speed measurement, gas measurement, infrared measurement, ultrasonic measurement, meter reading, etc. In some embodiments, the type of data may be peripheral data that is not associated with driving operations of a vehicle. For example, the type of data may be data collected by a sensor not supporting autonomous or semiautonomous driving (e.g., a temperature sensor, a gas sensor, etc.). An attribute of collection may be an indication of one or more requirements associated with collection of the data being requested. A data gathering request may include one or more attributes of collection. As an example, attributes of collection may include indications of one or more specific sensors to be used in gathering the data (e.g., the data should be gathered using a radar, the data should be gathered using a specific type of camera, the data should be gathered using a gas sensor, etc.). As an example, attributes of collection may include an indication of speed of travel at which the data should be gathered (e.g., a specific mph, a minimum mph, a maximum mph, etc.). As an example, attributes of collection may include an indication of a type of wireless connection to use in transmitting the data (e.g., 5G broadband connection, etc.). As an example, attributes of collection may include an indication of a time or duration over which the data should be gathered (e.g., a specific time period, a starting time, an ending time, etc.). As an example, attributes of collection may include indications of one or more data conditions (e.g., send data associated with a temperature that is above a threshold, send data associated with an acceleration measurement at or above a threshold, send data associated with one or more conditions, etc.). As an example, attributes of collection may include indications of the one or more conditions of the vehicle and/or any sensors utilized in gathering data as described.

In block 508, the data agency server may send the data gathering request to at least one vehicle. In various embodiments, the data gathering request may be a request for continuous data acquisition and transmission by the vehicle. For example, the request may indicate that the vehicle is to provide sensor data of one or more types continually to the data agency server. In various embodiments, the data gathering request may be a finite data gathering request. A finite data gathering request may be a request that does not require continual gathering and/or transmission of data by the vehicle. For example, a finite request may be a conditional request instructing the vehicle to gather data at a specific time, for a specific duration, and/or at a specific location. As another example, a finite request may be a conditional request instructing the vehicle to gather data and determine whether a data condition is met before transmitting gathered data to the data agency server. As a specific example, a data gathering request that may be a finite request may instruct a vehicle to gather acceleration sensor data, radar data, and video data and analyze gathered data to determine whether an auto accident condition with, or around, the vehicle has occurred (e.g., analyzing the data to detect Doppler effect measurements indicating an accident, images indicating an accident, accelerations indicating an accident, etc.). The finite request may indicate that the determination that an auto accident condition with, or around, the vehicle has occurred is a condition for sending gathered data. In response to no auto accident occurring, gathered data may not be sent. In response to an auto accident occurring, gathered data may be sent. Additionally, the data gathering request may indicate subsequent actions for the vehicle to take (e.g., continue uploading video, activate other sensors, take still images in all directions, maintain a copy of the gathered data, etc.), such as in the attributes of collection in the data gathering request.

In block 510, the data agency server may receive gathered data from at least one vehicle. For example, the data agency server may receive gathered data from at least one vehicle in response to sending the data gathering request to the at least one vehicle. In various embodiments, the gathered data may be received via wireless communications, such as C-V2X communications (e.g., C2N communications, etc.), etc., from a vehicle. As a specific example, the gathered data may be sent from the vehicle to the data agency server via a 5G broadband connection to a wireless network.

In optional block 511, the data agency server may process the gathered data. Processing gathered data may include validating gathered data, augmenting gathered data, anonymizing gathered data, indexing gathered data, storing gathered data in a database, and/or compensating an account associated with the vehicle providing gathered data. Processing may be optional as some data may be sent directly to an address of the data agency server that may make the vehicle sensor data directly available to a third-party entity, such as a data client server. In such a manner, the data agency server may support live streaming of vehicle sensor data to third party entities, such as data client servers.

In block 512, the data agency server may send the gathered data. In various embodiments, gathered data, whether processed or not processed, may be sent from the data agency server to a data client server. In this manner, a third-party entity, such as a data client server, may obtain sensor data from a vehicle.

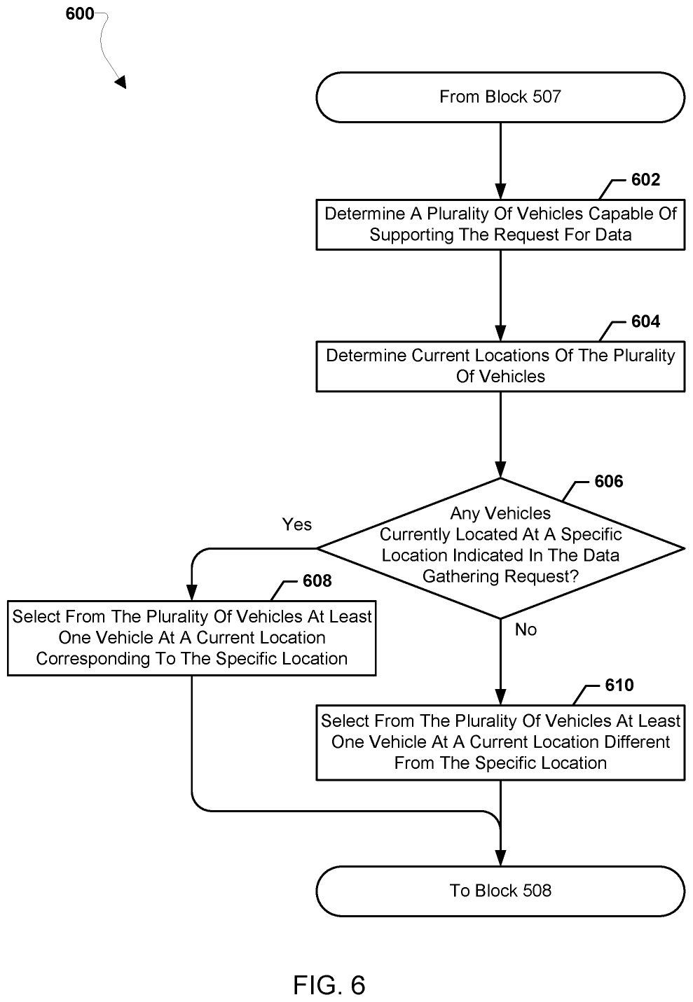

FIG. 6 illustrates a method 600 for selecting at least one vehicle according to various aspects. With reference to FIGS. 1A-6, the method 600 may be implemented in hardware components and/or software components of a data agency server (e.g., data agency server 410). In some embodiments, the operations of the method 600 may be performed in conjunction with the operations of methods 450 and/or 500. In some embodiments, the operations of method 600 may be performed subsequent to the operations of block 507 of method 500.

In block 602, the data agency server may determine a plurality of vehicles capable of supporting the data gathering request. Vehicles capable of supporting a data gathering request may be vehicles that have the necessary sensors, wireless connection capabilities, operational capabilities (e.g., top speed, etc.), and/or other characteristics to enable the vehicles to gather sensor data in a manner that may fulfill a data gathering request. In some embodiments, as part of registration with the data agency server, the capabilities of the vehicle (e.g., sensors, sensor status, operational capabilities, available wireless connections, etc.) may be reported by the vehicle to the data agency server. The data agency server may track the capabilities of all registered vehicles and may analyze the capabilities of the registered vehicles to determine a plurality of vehicles capable of supporting a data gathering request.

In block 604, the data agency server may determine current locations of the plurality of vehicles. For example, the data agency server may determine the current locations of the vehicles based on location data sent from the vehicles. In this manner, the data agency server may identify the current locations of vehicles capable of supporting the data gathering request.

In determination block 606, the data agency server may determine whether any vehicles are currently located at a specific location indicated in the request for data. For example, the data agency server may compare the current locations of a plurality of vehicles capable of supporting the data gathering request to a specific location indicated in the request for data to determine whether any vehicles are currently located at a specific location indicated in a request for data. Vehicles having the same location as the specific location (or a location within a threshold distance (e.g., a number of meters, etc.) of the specific location) may be determined to be currently located at the specific location. Vehicles having a different location than the specific location (or a location beyond a threshold distance (e.g., a number of meters, etc.) of the specific location) may be determined to not be currently located at the specific location.

In response to determining that a vehicle is currently located at a specific location indicated in the request for data (i.e., determination block 606=“Yes”), the data agency server may select from the plurality of vehicles at least one vehicle at a current location corresponding to the specific location in block 608.

In response to selecting from the plurality of vehicles, the data agency server may execute operations of method 500 in block 508 as described.

In response to determining that a vehicle is not currently located at a specific location indicated in the request for data (i.e., determination block 606=“No”), the data agency server may select from the plurality of vehicles at least one vehicle at a current location different from the specific location in block 610. The selection of one or more vehicles with a current location different from the specific location may result in a data gathering request being sent to those one or more vehicles capable of supporting the data gathering request with a current location different from the specific location.

In response to selecting from the plurality of vehicles, the data agency server may execute operations of method 500 in block 508 as described.

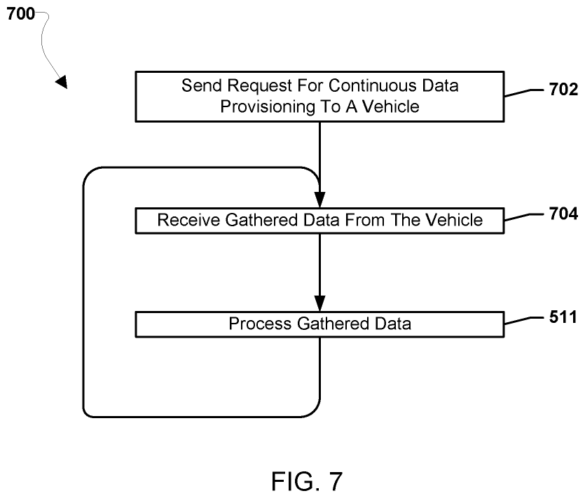

FIG. 7 illustrates a method 700 for obtaining sensor data from a vehicle according to various aspects. With reference to FIGS. 1A-7, the method 700 may be implemented in hardware components and/or software components of a data agency server (e.g., data agency server 410). In some embodiments, the operations of the method 700 may be performed in conjunction with the operations of methods 450, 500, and/or 600.

In block 702, the data agency server may send a request for continuous data acquisition and transmission to a vehicle. For example, the request may indicate that the vehicle is to provide sensor data of one or more types continually to the data agency server.

In block 704, the data agency server may receive gathered data from the vehicle. For example, the vehicle may send sensor data continually to the data agency server as it is gathered by the vehicle.

In block 511, the data agency server may process gathered data. Processing gathered data may include validating gathered data, augmenting gathered data, anonymizing gathered data, indexing gathered data, storing gathered data in a database, and/or compensating an account associated with the vehicle providing gathered data. In various embodiments, the continual reception and processing of gathered sensor data may enable a database of vehicle sensor data to include continuously updated vehicle sensor data.

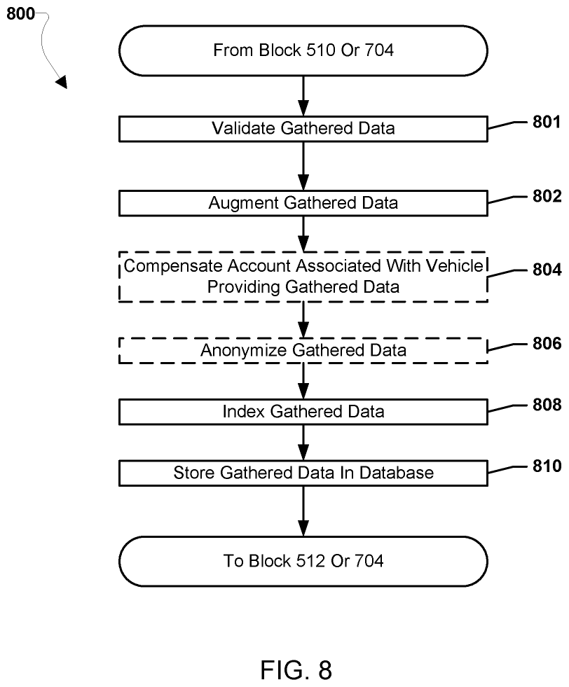

FIG. 8 illustrates a method 800 for processing gathered data according to various aspects. With reference to FIGS. 1A-8, the method 800 may be implemented in hardware components and/or software components of a data agency server (e.g., data agency server 410). In some embodiments, the operations of the method 800 may be performed in conjunction with the operations of methods 450, 500, 600, and/or 700. In some embodiments, the operations of method 800 may be performed subsequent to the operations of block 510 of method 500 or block 704 of method 700.

In block 801, the data agency server may validate gathered data. Validating gathered data may include comparing the type and location of gathered data to the type and location indicated in a request for data. Gathered data that does not match the requested type and location may be invalid and discarded. Validating may also include verifying a minimum quality threshold of gathered data or applying other threshold checks to the gathered data.

In block 802, the data agency server may augment gathered data. Augmenting the gathered sensor data may include adding location information (e.g., a GPS coordinate provided by the vehicle when sending the data, the tracked location of the vehicle stored at the data agency server, etc.) indicating where the data was gathered and time information (e.g., a timestamp from the message including gathered data, etc.) indicating the time at which the data was gathered to the gathered data itself. In this manner, augmented gathered data may itself identify when and where the data was collected.

In optional block 804, the data agency server may compensate an account associated with the vehicle providing the gathered data. In some embodiments, vehicle owners/operators may be compensated for their vehicles being utilized to obtain data. Compensation may be in the form of monetary compensation, reduced cost (or free) network access of data usage, or any other form of compensation. Compensation may be provided by the third-party entity requesting data from the data agency server when data is provided and a portion of that compensation may be passed onto the account associated with a vehicle providing gathered data. In this manner, the owner or operator of a vehicle may be compensated for providing sensor data from his or her vehicle. Compensation may be optional as compensation may not be always provided, such as in response to data gathering during a declared national emergency.

In optional block 806, the data agency server may anonymize gathered data. Anonymizing gathered data may include removing information from the data such that the identity of the vehicle that collected the data cannot be determined from the data. Anonymizing may be optional as it may not be required for all types of data or may not be desired by all entities, such as law enforcement organizations, insurance companies, etc.

In block 808, the data agency server may index gathered data. Indexing gathered data may include adding information to the gathered data to identify and make the data searchable by location, by type of data, by attributes of collection associated with the collection of the data itself (e.g., type of sensor used, speed of travel at gathering, type of wireless connection used to transmit the data, time the data was gathered, duration over which the data was gathered, etc.), etc.

In block 810, the data agency server may store gathered data in a database. The data agency server may store the augmented and indexed data in a database, such as a database of vehicle sensor data.

In response to storing the gathered data, the data agency server may execute operations of method 500 in block 512 or operations of method 700 in block 704 as described.

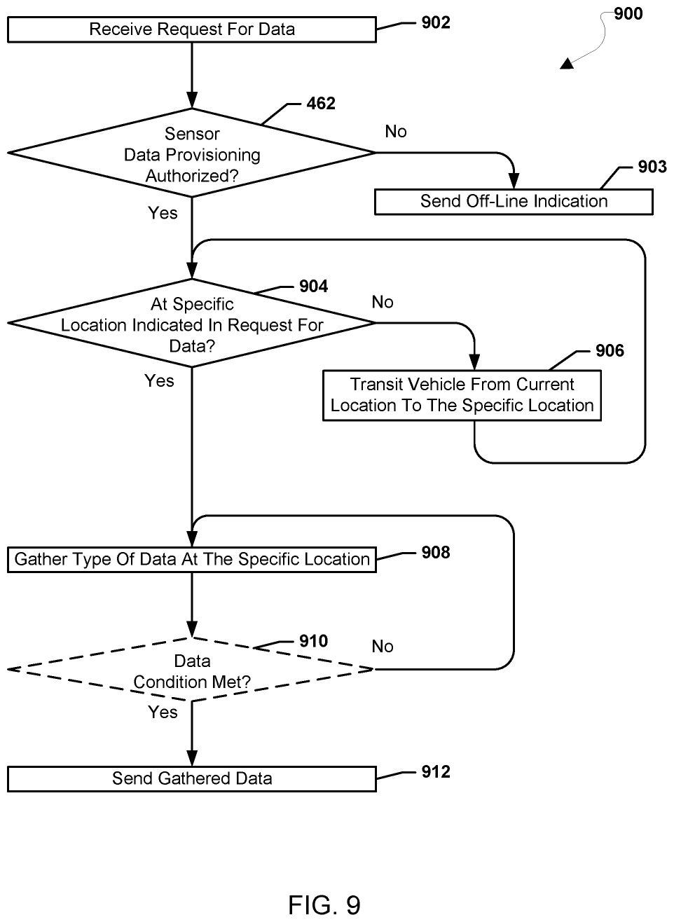

FIG. 9 illustrates a method 900 for obtaining sensor data from a vehicle according to various aspects. With reference to FIGS. 1A-9, the method 900 may be implemented in a processor (e.g., 164), a processing device (e.g., 300), and/or a control unit (e.g., 140) (variously referred to as a “processor”) of a vehicle (e.g., 100). In some embodiments, the method 900 may be performed by one or more layers within a vehicle control system stack 200. In other embodiments, the method 900 may be performed by a processor independently from, but in conjunction with, the vehicle control system stack 200. For example, the method 900 may be implemented as a stand-alone software module or within dedicated hardware that monitors data and commands from/within the vehicle control system stack 200 and is configured to take actions and store data as described. In various embodiments, the operations of method 900 may be performed in conjunction with the operations of methods 450, 500, 600, 700, and/or 800.

In block 902, the processor of the vehicle may receive a data gathering request. In various embodiments, a processor of a vehicle may receive a data gathering request, such as a data gathering request from a data agency server. As an example, the data gathering request may be a message indicating a type of data and a specific location at which to gather the type of data. In various embodiments, the data gathering request may further indicate an attribute of collection. The type of data, the specific location, and/or the attribute of collection in the data gathering request may correspond to a type of data, a specific location, and/or an attribute of collection indicated in a request for data received by a data agency server. A specific location at which data is to be gathered may be any type of indication of a location, such as a specific geographic point (e.g., a latitude and longitude, another type of coordinate, etc.), a specific geographic place (e.g., a parking lot name, a road intersection name, etc.), an address, a roadway name (e.g., a street name, a highway number, etc.), a geographic area (e.g., a county, a city, a country, a neighborhood, a park, etc.), a geofence (e.g., a radius extending from a coordinate, etc.), etc. The type of requested data may be an indication of the format of the data being requested, such as still image, video, audio, temperature measurement, radar measurement, lidar measurement, acceleration measurement, speed measurement, gas measurement, infrared measurement, ultrasonic measurement, meter reading, etc. In some embodiments, the type of data may be peripheral data that is not associated with driving operations of a vehicle. For example, the type of data may be data collected by a sensor not supporting autonomous or semiautonomous driving (e.g., a temperature sensor, a gas sensor, etc.). An attribute of collection may be an indication of one or more requirements associated with collection of the data being requested. A data gathering request may include one or more attributes of collection. As an example, attributes of collection may include indications of one or more specific sensors to be used in gathering the data (e.g., the data should be gathered using a radar, the data should be gathered using a specific type of camera, the data should be gathered using a gas sensor, etc.). As an example, attributes of collection may include an indication of speed of travel at which the data should be gathered (e.g., a specific mph, a minimum mph, a maximum mph, etc.). As an example, attributes of collection may include an indication of a type of wireless connection to use in transmitting the data (e.g., 5G broadband connection, etc.). As an example, attributes of collection may include an indication of a time or duration over which the data should be gathered (e.g., a specific time period, a starting time, an ending time, etc.). As an example, attributes of collection may include indications of one or more data conditions (e.g., send data associated with a temperature that is above a threshold, send data associated with an acceleration measurement at or above a threshold, send data associated with one or more conditions, etc.). As an example, attributes of collection may include indications of the one or more conditions of the vehicle and/or any sensors utilized in gathering data. Non-limiting examples of such indications may include: an indication of a specific speed and direction for the vehicle to be traveling during data gathering data; an indication a specific acceleration for the vehicle to be experiencing while gathering data; an indication of whether to have the headlight mode be “on” or “off” while gathering data; an indication of a height and angle of a camera to use in recording video, an indication of whether to have the engine be “on” or “off” while gathering data; an indication to follow a specific object while gathering data; an indication to follow a specific route while gathering data; etc.

In determination block 462, the processor of the vehicle may perform operations of determination block 462 of method 450 to determine whether sensor data acquisition and transmission is authorized. In response to determining sensor data acquisition and transmission is not authorized (i.e., determination block 462=“No”), the vehicle processor may send an off-line indication in block 903 to the data agency server.

In response to determining sensor data acquisition and transmission is authorized (i.e., determination block 462=“Yes”), the vehicle processor may determine whether the vehicle is at a specific location indicated in the data gathering request in determination block 904. A location may be any type of indication of a location, such as a geographic point (e.g., a latitude and longitude, another type of coordinate, etc.), an address, a geographic place (e.g., a parking lot name, a road intersection name, etc.), a roadway name (e.g., a street name, a highway number, etc.), a geographic area (e.g., a county, a city, a country, a neighborhood, a park, etc.), a geofence (e.g., a radius extending from a coordinate, etc.), etc. For example, the processor of the vehicle may compare the vehicle's current location to the specific location to determine whether the locations match.

In response to determining that the vehicle is not in the specific location (i.e., determination block 904=“No”), the processor drive the vehicle from the current location to the specific location in block 906. For example, the processor of the vehicle may control an autonomous or semiautonomous driving system to drive the vehicle to the specific location. In this manner, the processor of the vehicle may drive the vehicle from the current location to the specific location in response to receiving a data gathering request.

In response to determining that the vehicle is in the specific location (i.e., determination block 904=“Yes”), the processor of the vehicle may gather the type of data at the specific location in block 908. In various embodiments, the vehicle may gather a type of data at a specific location and send the gathered data to a data agency server. In various embodiments, a processor of a vehicle may gather sensor data according to the indications in the data gathering request. As an example, the data gathering request may be a message indicating a type of data, a specific location at which to gather the type of data, and/or one or more attributes of collection. The processor of the vehicle may control one or more sensors of the vehicle to gather the type of data at the specific location according to any attributes of collection.

In optional determination block 910, the processor of the vehicle may determine whether a data sending condition is met. In various embodiments, a data gathering request may be a finite request that may be a conditional request instructing the vehicle to gather data and determine whether a data condition is met before transmitting gathered data to the data agency server. As an example, attributes of collection may include indications of one or more data conditions (e.g., send data associated with a temperature that is above a threshold, send data associated with an acceleration measurement at or above a threshold, send data associated with one or more conditions, etc.). The processor of the vehicle may compare the gathered data to the one or more data conditions to determine whether a data sending condition is met. The gathered data matching the attributes of collection (e.g., having a temperature above a threshold, being associated with an acceleration measurement at or above a threshold, meeting one or more conditions, etc.) may indicate the data sending condition is met. The gathered data not matching the attributes of collection may indicate the sending condition is not met. Determining whether a data condition is met may be optional as all requests for data may not indicate attributes of collection that may be indications of one or more data conditions. As a specific example, a data gathering request that may be a finite request may instruct a vehicle to gather acceleration sensor data, radar data, and video data and analyze the gathered data to determine whether an auto accident condition with, or around, the vehicle has occurred (e.g., analyzing the data to detect Doppler effect measurements indicating an accident, images indicating an accident, accelerations indicating an accident, etc.). The finite request may indicate that the determination that an auto accident condition with, or around, the vehicle has occurred is a condition for sending the gathered data. In response to no auto accident occurring, the gathered data may not be sent. In response to an auto accident occurring, the gathered data may be sent.

In response to determining that a data sending condition is not met (i.e., determination block 910=“No”), the processor of the vehicle may gather the type of data at the specific location in block 908.

In response to determining that a data sending condition is met (i.e., determination block 910=“Yes”), the processor of the vehicle may send the gathered data in block 912. In some embodiments, the gathered sensor data may be sent to the data agency server in a message including the gathered data, an identifier of the vehicle sending the gathered data, and a location indication of the vehicle. In some embodiments, the gathered sensor data may be sent to the data agency server in a message include the gathered data and an identifier of the vehicle sending the gathered data. In various embodiments, the message sent including the gathered data may further include a timestamp indicating the time at which the data was gathered. In various embodiments, the gathered data may be sent via wireless communications, such as C-V2X communications (e.g., C2N communications, etc.), etc., to the data agency server. As a specific example, the gathered data may be sent from the vehicle to the data agency server via a 5G broadband connection to a wireless network. In various embodiments, the type of wireless connection to establish to send the gathered data may be indicated in the data gathering request received by the vehicle, such as in an attribute of collection. Additionally, the data gathering request may indicate subsequent actions for the vehicle to take (e.g., continue uploading video, activate other sensors, take still images in all directions, maintain a copy of the gathered data, etc.), such as in the attributes of collection in the data gathering request.

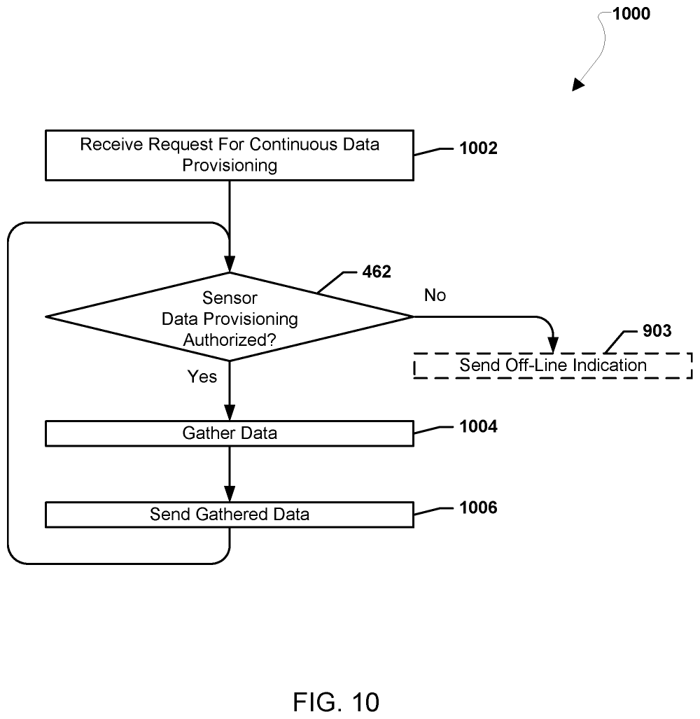

FIG. 10 illustrates a method 1000 for obtaining sensor data from a vehicle according to various aspects. With reference to FIGS. 1A-10, the method 1000 may be implemented in a processor (e.g., 164), a processing device (e.g., 300), and/or a control unit (e.g., 140) (variously referred to as a “processor”) of a vehicle (e.g., 100). In some embodiments, the method 1000 may be performed by one or more layers within a vehicle control system stack 200. In other embodiments, the method 900 may be performed by a processor independently from, but in conjunction with, the vehicle control system stack 200. For example, the method 1000 may be implemented as a stand-alone software module or within dedicated hardware that monitors data and commands from/within the vehicle control system stack 200 and is configured to take actions and store data as described. In various embodiments, the operations of method 1000 may be performed in conjunction with the operations of methods 450, 500, 600, 700, 800, and/or 900.

In block 1002, the processor of the vehicle may receive a request for continuous data acquisition and transmission. For example, the request may indicate that the vehicle is to provide sensor data of one or more types continually to the data agency server.

In determination block 462, the processor of the vehicle may perform operations of determination block 462 of method 450 to determine whether sensor data acquisition and transmission is authorized. In response to determining sensor data acquisition and transmission is not authorized (i.e., determination block 462=“No”), the vehicle processor may send an off-line indication in block 903 to the data agency server.

In response to determining sensor data acquisition and transmission is authorized (i.e., determination block 462=“Yes”), the vehicle processor may gather data in block 1004. In various embodiments, the vehicle may gather a type of data and send the gathered data to a data agency server. In various embodiments, a processor of a vehicle may gather sensor data according to the indications in the data gathering request. As an example, the data gathering request may be a message indicating a type of data and/or one or more attributes of collection. The processor of the vehicle may control one or more sensors of the vehicle to gather the type of data continuously according to any attributes of collection

In block 1006, the processor of the vehicle may send the gathered data. In some embodiments, the gathered sensor data may be sent to the data agency server in a message including the gathered data, an identifier of the vehicle sending the gathered data, and a location indication of the vehicle. In some embodiments, the gathered sensor data may be sent to the data agency server in a message include the gathered data and an identifier of the vehicle sending the gathered data. In various embodiments, the message sent including the gathered data may further include a timestamp indicating the time at which the data was gathered. In various embodiments, the gathered data may be sent via wireless communications, such as C-V2X communications (e.g., C2N communications, etc.), etc., to the data agency server. As a specific example, the gathered data may be sent from the vehicle to the data agency server via a 5G broadband connection to a wireless network. In various embodiments, the type of wireless connection to establish to send the gathered data may be indicated in the data gathering request received by the vehicle, such as in an attribute of collection. In response to sending the data in block 1006, the processor of the vehicle may determine whether sensor data acquisition and transmission is authorized in determination block 462.

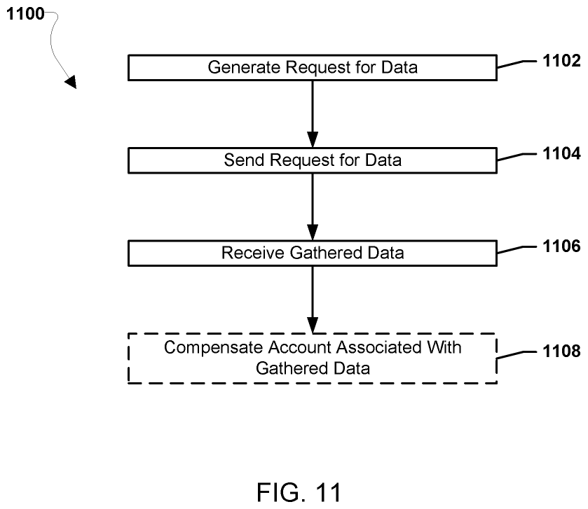

FIG. 11 is a process flow diagram of an example method for obtaining sensor data from a vehicle according to various aspects. With reference to FIGS. 1A-11, the method 1100 may be implemented in hardware components and/or software components of a data client server (e.g., data client server 420). In some embodiments, the operations of the method 1100 may be performed in conjunction with the operations of methods 450, 500, 600, 700, 800, 900, and/or 1000.

In block 1102, the data client server may generate a request for data. A request for data may be a request by the data client server to obtain vehicle sensor data from the data agency server. For example, the request for data may be a message requesting vehicle sensor data from the data agency server. In various embodiments, the request for data may indicate a specific location at which data is to be gathered and/or a type of requested data. A specific location at which data is to be gathered may be any type of indication of a location, such as a specific geographic point (e.g., a latitude and longitude, another type of coordinate, etc.), a specific geographic place (e.g., a parking lot name, a road intersection name, etc.), an address, a roadway name (e.g., a street name, a highway number, etc.), a geographic area (e.g., a county, a city, a country, a neighborhood, a park, etc.), a geofence (e.g., a radius extending from a coordinate, etc.), etc. The type of requested data may be an indication of the format of the data being requested, such as still image, video, audio, temperature measurement, radar measurement, lidar measurement, acceleration measurement, speed measurement, gas measurement, infrared measurement, ultrasonic measurement, meter reading, etc. In some embodiments, the type of data may be peripheral data that is not associated with driving operations of a vehicle. For example, the type of data may be data collected by a sensor not supporting autonomous or semiautonomous driving (e.g., a temperature sensor, a gas sensor, etc.).

In various embodiments, the request for data may additionally indicate an attribute of collection. An attribute of collection may be an indication of one or more requirements associated with collection of the data being requested. In some embodiments, an attribute of collection may set one or more conditions of the vehicle and/or any sensors utilized in gathering data, such as vehicle speed, vehicle direction, headlight mode, sensor angle, sensor height, sensor mode, engine state, etc. A request for data may include one or more attributes of collection. As an example, attributes of collection may include indications of one or more specific sensors to be used in gathering the data (e.g., the data should be gathered using a radar, the data should be gathered using a specific type of camera, the data should be gathered using a gas sensor, etc.). As an example, attributes of collection may include an indication of speed of travel at which the data should be gathered (e.g., a specific mph, a minimum mph, a maximum mph, etc.). As an example, attributes of collection may include an indication of a type of wireless connection to use in transmitting the data (e.g., 5G broadband connection, etc.). As an example, attributes of collection may include an indication of a time or duration over which the data should be gathered (e.g., a specific time period, a starting time, an ending time, etc.). As an example, attributes of collection may include indications of one or more data conditions (e.g., send data associated with a temperature that is above a threshold, send data associated with an acceleration measurement at or above a threshold, send data associated with one or more conditions, etc.). As an example, attributes of collection may include indications of the one or more conditions of the vehicle and/or any sensors utilized in gathering data. Non-limiting examples of such indications may include: an indication of a specific speed and direction for the vehicle to be traveling during data gathering data; an indication a specific acceleration for the vehicle to be experiencing while gathering data; an indication of whether to have the headlight mode be “on” or “off” while gathering data; an indication of a height and angle of a camera to use in recording video; an indication of whether to have the engine be “on” or “off” while gathering data; an indication to follow a specific object while gathering data; an indication to follow a specific route while gathering data; etc. Attributes of collection may enable third party client devices, such as data client servers, and the entities that control those devices to tailor requests for vehicle data.

In block 1104, the data client server may send the request for data. For example, the request for data may be sent over a network (e.g., the Internet) to a data agency server. In block 1106, the data client server may receive gathered data. In various embodiments, the gathered data may be sensor data from one or more vehicles. The data client server may receive gathered data from a data agency server. In some embodiments, the gathered data may be data processed by the data agency server. In some embodiments, the gathered data may be data vehicle sensor data made directly available to the data client server. In this manner, vehicle sensor data may be live streamed to the data client server from one or more vehicles via the data agency server.

In optional block 1108, the data client server may compensate an account associated with the gathered data. Compensation may be provided by the data client server to the data agency server when data is provided and a portion of that compensation may be passed onto the account associated with a vehicle providing the gathered data. In this manner, the owner or operator of a vehicle may be compensated for providing sensor data from his or her vehicle to the data client server. Compensation may be in the form of monetary compensation, reduced cost (or free) network access of data usage, or any other form of compensation. Compensation may be optional as compensation may not be always provided, such as in response to data gathering during a declared national emergency.

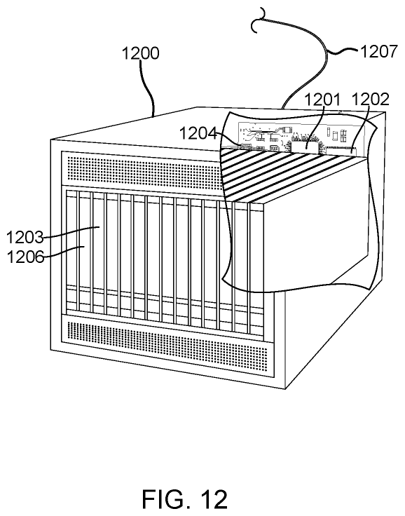

Various embodiments (including, but not limited to, embodiments discussed above with reference to FIGS. 1-11) may also be implemented on any of a variety of commercially available server devices, such as the server 1200 illustrated in FIG. 12. Such a server 1200 typically includes a processor 1201 coupled to volatile memory 1202 and a large capacity nonvolatile memory, such as a disk drive 1204. The server 1200 may also include a floppy disc drive, compact disc (CD) or digital versatile disc (DVD) disc drive 1206 coupled to the processor 1201. The server 1200 may also include one or more wired or wireless network transceivers 1203, such one or more network access ports and/or wired or wireless modems (e.g., one wireless modem, two wireless modems, three wireless modems, four wireless modems, or more than four wireless modems), coupled to the processor 1201 for establishing network interface connections with one or more communication networks 1207, such as a local area network (e.g., Ethernet, etc.) coupled to other computing devices and/or servers, the Internet, the public switched telephone network, and/or one or more cellular networks (e.g., CDMA, GSM, 3G, 4G, LTE, 5G, or any other type of cellular network).

The various processors described herein may include one or more cores, and each processor/core may perform operations independent of the other processors/cores. One or more of the processors may be configured with processor-executable instructions to perform operations of methods of various embodiments, including the methods 450, 500, 600, 700, 800, 900, 1000, and/or 1100. The processors may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory before they are accessed and loaded into one or more of the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors.

The foregoing method descriptions and the process flow diagrams are provided merely as illustrative examples and are not intended to require or imply that the steps of various embodiments should be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes CD, laser disc, optical disc, DVD, floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for obtaining sensor data from a vehicle, comprising:
receiving, in a processor of the vehicle, a data gathering request from a data agency server, wherein the data gathering request indicates a type of data and a specific location at which to gather the type of data;
gathering, by the processor of the vehicle, the type of data at the specific location; and
sending, by the processor of the vehicle, gathered data to the data agency server.

2. The method of claim 1, further comprising:
driving, by the processor of the vehicle, the vehicle from a current location to the specific location in response to receiving the data gathering request.

3. The method of claim 2, wherein the data gathering request further indicates an attribute of collection.

4. The method of claim 3, wherein the attribute of collection indicates a type of wireless connection to establish to send gathered data.

5. The method of claim 3, wherein the attribute of collection indicates a sensor to use in gathering the type of data.

6. The method of claim 3, wherein the attribute of collection indicates a time or duration for gathering the type of data.

7. The method of claim 2, wherein the type of data is data not associated with driving operations of the vehicle.

8. A method for obtaining sensor data from a vehicle, comprising:
receiving, in a data agency server, a request for data from a client server, the request for data indicating a specific location at which data is to be gathered and a type of requested data;
generating, by the data agency server, a data gathering request in response to receiving the request for data, the data gathering request indicating the type of requested data and the specific location;
sending, from the data agency server, the data gathering request to at least one vehicle; and
receiving, in the data agency server, data from the at least one vehicle, wherein the received data corresponds to data collected at the specific location and of the type of requested data.

9. The method of claim 8, further comprising:
sending, by the data agency server, the received data to the client server.

10. The method of claim 8, wherein sending, from the data agency server, the data gathering request to the at least one vehicle comprises sending, from the data agency server, the data gathering request to at least one vehicle at a current location different from the specific location.

11. The method of claim 10, further comprising:
selecting, by the data agency server, from a plurality of vehicles the at least one vehicle at the current location different from the specific location.

12. The method of claim 10, further comprising:
determining, by the data agency server, an attribute of collection, wherein the request for data further indicates the attribute of collection.

13. The method of claim 12, wherein the attribute of collection indicates a type of wireless connection to establish to send gathered data.

14. The method of claim 12, wherein the attribute of collection indicates a sensor to use in gathering the type of data.

15. The method of claim 12, wherein the attribute of collection indicates a time or duration for gathering the type of data.

16. The method of claim 10, wherein the type of data is peripheral data not associated with driving operations of the vehicle.

17. A system-on-chip for use in a vehicle, comprising:
a processor configured to:
receive a data gathering request from a data agency server, wherein the data gathering request indicates a type of data and a specific location at which to gather the type of data;
gather the type of data at the specific location; and
send gathered data to the data agency server.

18. The system-on-chip of claim 17, wherein the processor is further configured to drive a vehicle from a current location to the specific location in response to receiving the data gathering request.

19. The system-on-chip of claim 18, wherein the data gathering request further indicates an attribute of collection.

20. The system-on-chip of claim 19, wherein the attribute of collection indicates a type of wireless connection to establish to send gathered data.

21. The system-on-chip of claim 19, wherein the attribute of collection indicates a sensor to use in gathering the type of data.

22. The system-on-chip of claim 19, wherein the attribute of collection indicates a time or duration for gathering the type of data.

23. The system-on-chip of claim 18, wherein the type of data is data not associated with driving operations of the vehicle.

24. A server, comprising:
a processor configured with processor executable instructions to:
receive a request for data from a client server, the request for data indicating a specific location at which data is to be gathered and a type of requested data;
generate a data gathering request in response to receiving the request for data, the data gathering request indicating the type of requested data and the specific location;
send the data gathering request to at least one vehicle; and
receive data from the at least one vehicle, wherein the received data corresponds to data collected at the specific location and of the type of requested data.

25. The server of claim 24, wherein the processor is further configured with processor executable instructions to:
send the received data to the client server.

26. The server of claim 24, wherein the processor is configured with processor executable instructions to send the data gathering request to least one vehicle at a current location different from the specific location.

27. The server of claim 26, wherein the processor is further configured with processor executable instructions to:
select from a plurality of vehicles the at least one vehicle at the current location different from the specific location.

28. The server of claim 26, wherein the processor is further configured with processor executable instructions to:
determine an attribute of collection, wherein the request for data further indicates the attribute of collection.

29. The server of claim 28, wherein the attribute of collection indicates one or more of: a speed of travel while gathering the type of data; a type of wireless connection to establish to send gathered data; a sensor to use in gathering the type of data; an address to which to send gathered data; or a time or duration for gathering the type of data.

30. The server of claim 26, wherein the type of data is peripheral data not associated with driving operations of the least one vehicle.
